(19) United States
(12) Patent Application Publication
(10) Pub. No.: US 2022/0040946 A1
(43) Pub. Date: Feb. 10, 2022

(54) LAYERED MATERIAL AND METHOD FOR PRODUCING A LAYERED MATERIAL

(71) Applicant: Philipp Schaefer, Hannover (DE)

(72) Inventor: Philipp Schaefer, Hannover (DE)

(21) Appl. No.: 17/312,338

(22) PCT Filed: Jul. 19, 2019
(86) PCT No.: PCT/EP2019/069529

§ 371 Date: Jun. 9, 2021

(30) Foreign Application Priority Data
Dec. 13, 2018 (AT) A51107/2018
Apr. 9, 2019 (AT) A50310/2019
Apr. 18, 2019 (AT) A50354/2019
Apr. 18, 2019 (DE) 10 2019 110 290.1

(51) Int. Cl. B29D 99/00; B32B 3/26; B32B 5/02; B32B 5/18; B32B 5/24; B32B 9/02; B32B 9/04; B32B 27/12; B32B 27/40; B32B 27/30

(52) U.S. Cl. CPC B29D 99/0092; B29K 2075/00; B32B 5/024; B32B 5/026; B32B 5/18; B32B 5/245; B32B 9/025; B32B 9/046; B32B 27/12; B32B 27/40; B32B 27/304; B32B 2266/0278; B32B 2266/104; B32B 2250/05; B32B 2307/732; B32B 2307/718; B32B 2307/536; B32B 2601/00; B32B 2437/02; B32B 3/266

(57) ABSTRACT

The invention relates to a method for producing a surface-structured layered material which has a backing layer (I) and a polyurethane layer (2) connected thereto, the backing layer (I) used, in particular in pieces, being a leather, preferably a smoothed full-grain leather or a split cowskin, a textile material, preferably a woven fabric or a knitted fabric, a cellulose fibre material, a split foam, a leather fibre material or a microfibre fleece and being connected to the layer (2), and the layer (2) applied to the backing layer (I) being at least one, preferably a single layer formed of a PU foam, in particular containing gas pockets, preferably a whipped PU foam optionally containing hollow microspheres and/or a PU foam containing hollow microspheres. According to the invention: —the PU foam, in particular containing gas pockets, is created with a PU dispersion mixture, wherein the individual PU dispersions used to create the PU dispersion mixture exhibit different softening points in the dry state; —to create the PU dispersion mixture, one or more PU dispersions having heat—preferably melting and contact adhesive properties and a softening point in the dry state greater than 40° C., preferably greater than 45° C., in an amount of 18 to 52 wt ¾ of the finished PU dispersion mixture is/are mixed with one or more PU dispersions without melting and contact adhesive properties and with a softening point greater than 95° C., preferably greater than 125° C., in an amount of 39 to 73 wt ¾ of the finished PU dispersion mixture; —the PU dispersion mixture for the layer (2) is applied to the backing layer (I) with a thickness such that the layer has a thickness in the dried state of 0.075 to 0.450 mm, preferably 0.150 to 0.280 mm; —before or during structuring of the PU foam, a further layer (3) of a non-foamed PU dispersion which is a mixture of multiple PU dispersions is applied to the layer (2); —the backing layer (I) is optionally cut or punched into banks or pattern parts before or after the application of the PU foam, in particular after the drying thereof, and the coated blanks or pattern parts are subjected to stamping or structuring under pressure and temperature; and —the backing layer (1), the further layer (3) and the layer (2) are compressed and joined to one another and structured with a die (4) under application of a contact pressure of 4 to 48 kg/cm2, preferably 4 to 48 kg/cm2, in particular 18 to 25 kg/cm2.

The invention refers to a method concerning the production of a layer material, according to the generic term of patent claim 1.

Furthermore, the invention refers to a layer material, according to the generic term of patent claim 11, as well as according to the method, namely under the use of objects obtainable with a layer material, according to the invention.

EP 3248833 A1 describes the production of a seat cover for motor vehicles. A four-layer layer material is prepared for this purpose, comprising a backing layer and a layer of polyurethane bonded to this backing layer, wherein the backing layer is a textile fabric. The layer is a layer of a non-crosslinked or under-crosslinked PU foam which is dried, wherein the layer has a softening point above 90° C. and is adhesive at a temperature between 110 and 165° C., has thermoplastic properties and is flowable and deformable under pressure. An additional layer of a non-foamed PU dispersion is applied to the layer and bonded to it. The PU dispersion mixture for the layer is applied to the backing layer with a thickness such that it has a thickness of 0.075 to 0.450 mm in the dried state. Before structuring this composite material, a top layer is applied to the additional layer.

This seat cover is necessarily composed of four layers. The applied top layer of the seat cover is provided with a pattern. This top layer is not completely structured, but only superficially provided with the pattern.

When structuring the top layer, the procedure is such that the PU foam bubbles in the layer are not deformed or damaged due to the pressure to be applied. There is no deformation or structuring of the layer and the additional layer. In this layer material, consisting of four layers, a pattern is formed exclusively on the surface of the outermost or overlying layer. The pressure applied for the structuring is between 0.5 and 0.6 kg/cm². Only textile backing material is provided for the creation of the four-layer composite material, in which a structure is introduced only into the uppermost surface and the layer formed with PU-PVC foam is to remain as untouched and undeformed as possible.

From EP 1887128 A1 a three-layer artificial leather is known, comprising a backing layer and a layer of polyurethane bonded thereto, wherein the backing layer is a textile fabric. The layer is a cross-linked or under-crosslinked PU foam which is water-free, wherein the layer has a softening point above 90° C. and is adhesive at a temperature between 110 and 165° C., has thermoplastic properties and is flowable and deformable under pressure. An additional layer of a non-foamed PU dispersion is applied to the layer and bonded to it. Micropores are formed in the top layer of this three-layer synthetic leather. The micropores in the top layer are created by applying heat, if necessary, with simultaneous formation of a surface structure. This top layer, which is produced on its own, is then bonded to an intermediate layer, which is then bonded to a textile backing layer. In this process, the underlay is applied to the top layer, which is already provided with micropores and with the structure, whereby the intermediate layer is still formed between the backing layer and the top layer, which is formed with a PU foam. The structure formed in the top layer does not extend into the intermediate layer formed from PU foam, as the top layer is finished on its own and is only then connected to the additional layers. The surface of the top layer is formed by vacuum stamping.

From DE 102017109453 A1, EP 1300474 A1 and WO 2009/049728 A2 different processes for the production of leathers or artificial leathers are known, which are constructed in several layers.

In EP 1644539-B1, continuous capillaries are described by means of a PU coating. The structuring of the coating is carried out on a mould made of silicone rubber. The polyurethane dispersion or mixture, in what concerns the structuring layer, is applied to the negatively structured mould, and dried and solidified by means of heat. The mould itself does not absorb water, as such, water removal can only be done over and/or through the surface of the coating. The same applies, if the structuring is carried out on a negatively structured release paper. The structuring thus takes place in-situ, upon the drying and solidification of the polyurethane dispersion top layer. It is cross-linked and cannot be restructured after a 48-hour storage period. Since the failure-free drying of thicker dispersion mixtures is especially complicated, i.e., if no moisture can be dissipated into the temporary support, the drying process must be carried out with the help of an increasing temperature. For this, a high energy input is necessary, because not only the dispersion layer must be heated, but also the intermediate backing layer. Due to the evaporation of the applied layer, heat is also extracted from the backing layer, which has to be supplied again and again. An essential task of the invention refers to the saving of energy and the associated reduction of emissions.

The formation of capillaries is possible only in regard to thin coatings. Their number per unit area and their diameter are difficult to control, due to the fact that they are formed as holes in the coating, during the solidification of the PU dispersion on the mould, which must communicate with holes or thin areas in the adhesive layer. The coating is cross-linked and cannot be restructured and, even if this were possible, the capillaries would be sealed, due to the high pressure required for re-stamping. These coatings display a uniform structure on the surface. The same applies in what concerns so-called corrected full-grain leather with a foamed polyurethane coating. The invention aims, among other things, to diminish these disadvantages and to create cut-to-size parts and stamped parts for the processing industry, namely the formation of individual surfaces, which can also have technical functions, e.g., the formation of stamped parts for shoes, which have different structures on one part and, if applicable, also have evenly distributed or precisely formed capillaries. According to the invention, a layer material is created, which does not show these defects, and which builds the prerequisite for the creation of precise cut-to-size parts, which can be cost-effectively structured, with any desired surface in the processing industry. The invention enables technicians and product designers, e.g., in a shoe factory, to individually design the surface.

The production of moulds in 3D, for example for surfaces with a technical function, is digitally simple, and can be carried out quickly, with the help of small moulds.

A further task of the invention is to coat leather and to structure the cut-out parts in such a manner that only waste resulting from the stamping parts is generated, due to the fact that even the parts of the hide with low thickness and looseness, which normally represent waste, can be provided with a structure that is suitable for the material. This is mainly achieved by means of stamping parameters, pressure and temperature, as well as pressure-elastic materials of the press and stamping moulds.

According to the task, only energy should be required for the structuring of cut-to-size and stamped parts, fact which also leads to a considerable energy saving. The task also includes the prolongation of the lifetime of silicone rubber moulds, as the structuring moulds should not come into contact with polyurethane dispersions containing wet polyisocyanate, as a cross-linking agent. In addition to silicone rubber moulds, the invention also aims to use moulds with textile surfaces, for the structuring of cut-to-size parts and stamped parts. The textile moulds are not suitable in what concerns wet application of dispersion coatings.

In the known processes, in which the structuring in larger areas is carried out in-situ, the residence time of the dispersion or the dispersion mixtures for the structuring surface is between 2 and 5 minutes. According to the task, this time should be reduced to a few seconds.

Known materials or coatings produced on reversible moulds consist of several layers. Layer separations are therefore pre-programmed. However, a layered structure also creates a so-called plywood effect, i.e., the base materials automatically become stiffer, subsequent to coating. The known layer materials are relatively hard.

According to the invention, soft layer materials are to be produced with a homogeneous-looking surface, which during hot stamping—due to their foam structure, as provided according to the invention—prevent the full temperature of the mould from being transferred to the backing layer during injection. High temperatures are perceived as stress, in both microfiber fleece and leather, and the base materials harden and lose strength, especially when moisture, heat and pressure act together on the backing layer.

The essential task of the invention is to produce a layered material, which is easy to manufacture and store and that ensures a precise surface structuring, in particular in what concerns cut-to-size parts and stamped parts that has the best mechanical and physical properties and that can be economically manufactured and processed. The layer should have a single-layer structure of aqueous PU dispersions and should not include any cavities, sink marks, bubbles or cracks that form during drying, even in case of a thickness of more than 0.4 mm. Furthermore, the wet coating should not lose its full water content in terms of thickness during drying or dehydration.

A further essential task of the invention is to create a layer material, with a flat, structureless, two-dimensional coating surface, in such a manner that the coating can be stamped with any individual structuring, and assumes or retains a three-dimensional structure, even after a storage time of over six months, without incurring any loss of quality, at a low cost. Thus, the stamping of the layer material should be possible for a longer period after the production of the layers. This is mainly achieved with the special type of PU foam used, especially due to its thermoplasticity and composition.

In order to be able to react to technical changes in a quick, uncomplicated and cost-effective manner, in particular irrespective of time and place, it is possible, according to the invention, e.g., in a shoe factory or other layer material processing companies, to cut or die-cut a cut-to-size part out of the layer material, and to provide it with the required structure by means of a mould, preferably created using a 3D printing process.

A further task of the invention is to create a layer material, whose layers can be created with PU dispersions on a purely aqueous basis.

Based on DE 4230997 A1, there is knowledge of a process, in which a layer material is produced, by means of applying a PU foam, produced from a PU dispersion mixture, onto a backing layer, and by structuring it with a metal roller. The disadvantages of this described procedure are significant, in particular because, in contrast to the invention, there is no matching of the stamping parameters, the structure of the dispersions and the stamping tools.

According to the invention, a method similar to that mentioned at the beginning is characterized by the features mentioned in the identifier of claim 1.

With the help of this procedure, a layer material is obtained, in which a backing layer carries a surface-structural layer, which can be optimally processed, even after longer storage periods. For this purpose, it is only necessary to thermally activate the surface-structural layer and to thermoplastically deform it above its softening point, using a mould under heat and applied pressure. The layer and the other subsequent layers retain their structure, after being removed from the mould. By means of applying pressure, a practically inseparable layer material is obtained, which faithfully reproduces the shape of the mould, mainly due to the thickness of the layer and the selected stamping pressure. The layer of PU foam applied to the backing layer and the other, non-foamed layer are structured. The consistency of the backing layer is not negatively affected by the exertion of pressure. The pressure range, according to the invention, takes into account the consistency of PU foams used, and structures, without significantly changing the foam structure. The stamping process can be carried out economically for smaller pre-cut and stamped parts.

It is advantageous, if the layer is dried to a water content of less than 1.5 m %, preferably less than 0.5 m %, in particular until the layer is free of water, after application to the backing layer, before structuring. This is advantageous for the application of other layers and for stamping. In order to produce PU foam or foam containing hollow microspheres, an aqueous PU-dispersion mixture, based on aliphatic and/or aromatic polyether and/or polyester and/or polycarbonate polyurethane is used. PU foam is also produced with a PU dispersion mixture, in which the individual, well-miscible PU dispersions that are used to produce the PU dispersion mixture display different temperatures of their softening point, in a dried state. The PU dispersions are selected in such a manner that the PU dispersion mixture possesses or retains thermoplastic contact adhesive properties after drying and any possible cross-linking, which is only sub-crosslinking, also after its stamping or structuring.

A foamable PU dispersion mixture contains between 65 and 91% by weight of polyurethane dispersions, based on the total weight of the PU foam, with all the additives. These additives are, for example, polyacrylate dispersions, thickeners, pigments, flame retardant additives, foaming agents, cross-linking agents. PU dispersion mixture, which contain solids between 35 and 52% by weight of the respective PU dispersion, are used.

The softening point and the adhesive properties of the PU foam cannot only be determined by means of selecting the softening point of the individual PU dispersions but can also be controlled by means of adding cross-linking agents. Advantageously, 0 to 4.2 m % cross-linking agents are used, based on the total weight of the PU foam. One such cross-linking agent is, for instance, the XL80 cross-linking agent from Lanxess AG.

Advantageously, PU dispersions are used, which, in the dried, not cross-linked or under-cross-linked state, have a softening point above 45° C., and, which, thus, become soft and sticky above this temperature threshold. The softening point can also be above 95° C., when cross-linking agents are used, to the extent according to the invention. Before and after under-crosslinking, the dried PU dispersion mixture should have thermoplastic properties, and the PU dispersion mixture is flowable under pressure, above the softening point, and can be permanently deformed. For the stamping process, the layer of PU foam should be honey-like, viscous, but not highly fluid, in order for it to be able to adopt the structure of the mould precisely and quickly. Depending on the purpose of the layer material, the softening point and the adhesive properties can be adjusted or selected.

Both for the preparation of the part of the PU dispersion mixture with hot-melt or contact adhesive properties and for the part of the PU dispersion mixture without such properties, both parts being mixed for the preparation of the PU foam, it is possible to use several PU dispersions, which have or form the desired properties in each case.

Anhydrous polyacrylate-based thickeners, with a highly fluid consistency or ammonia-containing foaming pastes, such as Millio-Form, are used to produce the PU foam. Polyacrylate-based thickeners, which stabilize the PU foam, are used in an amount of 1.5 to 5% by weight of the total weight of the PU foam.

PU dispersions based on aliphatic polyether and/or polyester and/or polycarbonate polyurethanes are used for the preparation of the PU foam. The PU dispersions used for the preparation of the PU dispersion mixture can have different temperatures for their respective softening points or are selected or mixed together according to this characteristic. It is thus possible to specifically set different softening points or softening ranges for the dried PU foam. When heating the material to this desired softening point, or above it, or to a softening range that allows stamping, it is possible to permanently provide the surface of the anhydrous or almost anhydrous, thermoplastic or thermoplastic-structural PU foam with a desired surface structure.

The use of different PU dispersions is mainly carried out, in order to adjust or optimize hydrolysis resistance, adhesion, softness and stamping ability of the PU foam, and to adapt it for various applications.

The PU dispersions used to produce the PU foam advantageously contain, in each case, 35 to 52% by weight of PU solids, based on the relevant weight of the PU dispersion used, together with its additives. The individual PU dispersions are then mixed, in order to form the PU dispersion mixture, and the PU dispersion mixture used to produce the PU foam contains 65 to 91% by weight of such PU dispersions, based on the total weight of the PU foam, including all additives.

According to the invention, particularly positive properties in what concerns the adhesion of the layer to the backing layer are achieved, when a PU dispersion mixture is used that contains between 18 and 52% by weight—based on the finished PU dispersion mixture—of a commercial polyester-based PU dispersion, with a solids content of about 40%, such as, for example, heat-activated industrial contact adhesive, marketed under the name Luphen, from BASF. The remaining 39 to 73% by weight are formed by a PU dispersion also containing about 40% solids, with a softening point of above 125° C., for example a PU dispersion named DLV-N, from Lanxess AG. This mixture leads to exceptionally high adhesion properties, especially with microfiber fleeces and smoothed grain leathers, without significantly hardening the finished product.

The heat-activated polyurethane of the advantageously applicable PU dispersions exhibits at least a partially linear and/or at least partially crystalline structure, and, in a dry state, is thermoplastically deformable and, as a PU foam, is also compressible.

The PU dispersions for the PU dispersion mixture for the production of the PU foam have a pH value of 6 to 9.5.

It is advantageous, in the case of longer storage, if the dried PU foam is water-free and not cross-linked or under-cross-linked, and if it softens or becomes adhesive at a temperature of 110 to 160° C., or melts highly viscously, and flows under the provided pressure, in order for it to be able to take on the structure of the mould.

The PU foam is created by means of introducing a gas, preferably air or nitrogen, into the PU dispersion mixture, wherein so much gas and/or hollow microspheres are introduced or stamped into one litre of the PU dispersion mixture, that one litre of the outlet material takes on a volume of 1.10 to 1.70 l, preferably 1.20 to 1.50 l.

The process, according to the invention, is simple and economical. It is possible that the PU foam is sprayed onto the backing layer, especially in an airless manner, or applied by means of the screen-printing method, or with at least one roller or a scraper, in the same thickness. This way, it is easy to set the desired thickness of the layer of PU foam that is to be applied, which is ultimately also important in what concerns the properties of the layer material.

For special application purposes, it can be advantageous if, before or at the same time as the structuring of the PU foam with the mould, which is carried out under pressure, another layer of a PU dispersion, which may have a different colour, is applied or bonded directly to the layer. After solidification or drying, this layer has a thickness of 0.015 to 0.060 mm, preferably 0.020 to 0.045 mm. This way, in addition to a protective effect for the foam layer, a different colouring can be achieved, in what concerns the surface of the layer material. If sections of the applied layer are removed, e.g., by means of laser, and the applied additional layer has a different colour than the PU foam, differently designed patterns can be produced on the layer material. The application of the additional layer can be carried out directly on the PU foam that is already on the backing layer and, advantageously, already dried. However, it is also possible to apply this additional thin layer before the PU foam is pressed onto the mould and, in the course of stamping of the PU foam, to apply the additional layer located on the mould directly, with the mould, onto the surface of the PU foam, or to connect it, by means of applying pressure, or to transfer it to this surface.

The backing layer or the layer material provided with the layer of dried PU foam can be manufactured in meter goods or in the form of pre-cut parts, and can be stored accordingly, after the PU foam has dried.

According to the invention, in order to produce a surface-structured layer material, the dried layer is subjected to pressure with a structured mould, if necessary, at the same time or together with the other layer, and, thus, thickness is reduced, if necessary. The bond between the layer and the backing layer is thusly further improved. This is advantageously carried out at a temperature of 110 to 160° C. A dwell time of 2 to 28 s, preferably 6 to 18 s, and a contact pressure of 4 to 48 kg/cm² are maintained. In what concerns the structuring, the layer of PU foam can be brought to a temperature of 110 to 160° C., e.g., with IR radiation, if necessary, simultaneously or together with the other layer, subjected to pressure and structured and, if necessary, its thickness can be reduced. For a quick and precise structuring, it may be provided that the backing layer, the additional layer and the layer are pressed and bonded to each other, by means of applying a contact pressure of 0.8 to 48 kg/cm², preferably of 4 to 48 kg/cm², in particular of 18 to 25 kg/cm², and structured with a mould.

It may be provided that the PU foam contains additives, e.g., pigments and/or polyacrylate dispersions and/or silicones and/or delustering agents and/or thickeners and/or cross-linking agents and/or flame retardants. Based on the total weight of the PU foam, 1.5 to 3.5% by weight of hollow microspheres, or 2 to 12% by weight of pigments, or 1.8 to 4.5% by weight of polyacrylates, as thickeners and foam stabilizers, or 1 to 4% by weight of silicones may be added.

According to the invention, the PU foam can be produced in such a manner that the layer exhibits a density of 0.80 to 1.05 g/cm³ or 0.89 to 1.05 g/cm³, after the structuring with the mould. The density depends, essentially, on the type and number of pigments. A PU foam coloured in white, with titanium dioxide, naturally has a higher density than a black PU foam. However, the thickness also exerts a certain influence on the viscosity and stamping ability of the PU foam.

In practice, it is advantageous to add a cross-linking agent to the PU foam, in the amount of up to 4.2% by weight and/or 8 to 25% by weight of a 40 to 60% acrylate dispersion. The weight specifications refer to the total weight of the PU foam. The PU foam is, in any case, not cross-linked or not completely cross-linked, and remains thermoplastically deformable, after an initial structuring process.

The additional layer applied to the surface of the dried PU foam does not have to be thermoplastic but is advantageously resistant to heat abrasion and MEK and isopropanol. The additional layer, even if it is not thermoplastic, takes on the structure of the PU layer and that of the mould. In particular, the colour pigments used with the additional layer can have a different colour, in comparison to the layer itself.

For the production of a layer material, in which a textile fabric, e.g. a woven or knitted fabric, is used as a backing layer, it has proved to be particularly advantageous if, before the layer of PU foam is applied to a backing layer made of a textile fabric, e.g. a woven or knitted fabric, a thin layer of PU foam or of possibly foamed soft PVC is applied to the surface of the textile fabric, as a pre-coat, each with a thickness of 0.25 to 0.40 mm, or of a equipollent cross-linked PU dispersion foam layer or a polyacrylate foam layer. The backing layer is thus coated with a layer of foamed soft PVC or a cross-linked PU foam or a polyacrylate layer.

A layer material according to the invention is characterized by the features stated in claim 11. Such a layer material can be surface-structured, even after a long storage period, at an elevated temperature and by means of simultaneously applying pressure, since it is not cross-linked or is produced without a cross-linking agent or is under-cross-linked and can thusly be and remain thermoplastically deformable.

The PU foam of the layer material has a specific weight of 0.8 to 1.05 kg/dm³. The layer of PU foam has a thickness of 0.030 to 0.450 mm, preferably 0.075 to 0.450 mm. Polyurethanes are used for the layer, advantageously aliphatic or aromatic polyurethanes, based on polyether or polyester or polycarbonate. The layer of PU foam may contain pigments and/or cross-linking agents and/or polyacrylates and, if necessary, the provided hollow microspheres, instead of an injected gas. The layer of solidified, dried PU foam advantageously has a Shore A hardness of 28 to 68. A structuring is formed or stamped on the surface of the layer and the additional layer applied to the layer. The structured layer, even if it contains cross-linking agents, i.e. is under-cross-linked, is and remains thermoplastic. The layer of PU foam has a thickness that is only 2 to 18%, preferably 3 to 9%, thicker than a layer that is formed from an equal quantity of non-foamed PU dispersion or non-foamed PU dispersion mixture of the same composition, after this quantity has been distributed over an area of the same size as the PU foam.

The measurement of the Shore A hardness is carried out in such a manner that a large number of the layers to be examined are made from the respective material, preferably from a solidified or dried or structured PU foam, and stacked accordingly, thus creating a test body with a thickness of 5 mm, according to the DIN ISO 7619-1 standard, which is then measured.

The usability and processability of the layer material is optimized, namely a surface protection of the structured PU foam is achieved, if, in the case of a backing layer formed out of a textile fabric, a thin layer of foamed soft PVC or cross-linked PU dispersion or cross-linked PU dispersion mixture, preferably of aliphatic polyurethane on a polyester or polyether or polycarbonate basis, or polyacrylate dispersion, is applied between the surface of the textile fabric and the layer, which has a thickness of 0.25 to 0.40 mm, and represents a link layer, in which the layer of PU foam is to be applied, the two layers optionally forming a total thickness of 0.35 to 0.60 mm.

Advantageously, a thin, heat-structural, non-foamed, additional layer of a dried PU dispersion, with a thickness of 0.0150 to 0.060 mm, preferably 0.020 to 0.0450 mm, is applied to the surface of the layer or is bonded to the layer, wherein a structure corresponding to the structural stamping in the layer is formed, namely stamped in the additional layer of PU foam. The additional layer advantageously has a higher Shore A hardness, when compared to the layer of PU foam, and has a hardness of more than 70 Shore A and, optionally, contains 1 to 4% by weight polysiloxanes. The additional layer preferably consists of more than 45% by weight of polyether polyurethane based on polycarbonate, such as Aquaderm Finish HW2, from Lanxess AG.

If leather is used as the backing layer, it has proven advantageous, if the grain leather is full-grain cowhide, preferably cow split leather, calf leather, goat leather, pig leather, sheep leather, water buffalo leather or kangaroo leather, in relation to which the grain layer is advantageously mechanically removed by at least 5%, to a maximum of 60%. A leather fibre reusable material may contain shredded punching waste from the upper leather, and/or synthetic fibres.

If a microfiber fleece is provided as the backing layer, it is advantageous, if the fibres of the microfiber fleece consist of polyester or polyamide, whereby the cavities between the fibres are impregnated, namely filled, with a plastic, preferably polyurethane-based, which has a foam structure or a coagulated microcell structure.

The PU foam can advantageously have an open-cell structure and/or be permeable to air and/or have a water vapour permeability of more than 0.050 mg/cm²/h, preferably more than 0.12 mg/cm²/h, according to DIN EN ISO 14268, which is particularly advantageous for stamped parts for shoes.

According to the invention, the layer material is particularly advantageous for the manufacture of articles such as pre-cut parts, stamped parts, shoe parts, sports and work shoes, shoe insoles, bags, leather goods, steering wheel covers, upholstery covers, interior wall linings and seat covers for motor vehicles, and partial coating for the protective area of fabrics, such as uniforms, work clothing, safety clothing.

The articles produced according to the invention feature a surface that can be designed as desired, by means of a mould, in which grain leather structures, textile structures, geometric structures, name markings, logos and, also, surface areas of different structure and/or different roughness can be formed. For this purpose, it is only necessary to design the structuring surface of the mould made of silicone rubber or silicone resin accordingly. The design of the mould's surfaces can be achieved by means of moulding, for example, of a textile, mechanically or by means of laser ablation, or in a 3D printing process. For this purpose, the mould used for structuring in the production of layer material does not necessarily have to have been surface-machined, but the mould used can also be a negative mould of an originally created positive mould.

The invention ensures material savings in what concerns the polyurethane to be used, since the PU dispersions are foamed, namely contain gas, and, thus, the quantity of polyurethane required is thereby reduced by the gas bubbles contained in the PU foam. This also results in a lower weight for the layer of PU foam. Only water-based PU dispersions are used, which means that the production is environmentally friendly, and not harmful, namely environmentally damaging process residues are avoided. Finally, a quick change of different moulds is possible when stamping parts, and, thus, an individual production of objects with different surface designs is easily feasible. It is particularly advantageous, if the backing layer of pre-cut parts has been coated with PU foam, by means of using the screen-printing process. There is no need in that case to dispose of the backing layer waste, namely the PU foam is only applied to the pre-cut part and the PU foam does not leave any backing layer residues. It is particularly advantageous and economical, if small format parts or stamped parts are detached from a large-area layer material coated with PU foam, and then subsequently stamped. Such stamped parts can easily be stored temporarily before being punched.

According to the invention, the structuring of format parts and stamped parts is easy to handle, in contrast to whole leather skins or meter goods. In what concerns the individual design of the surface, the format parts or the stamped parts, e.g., in a shoe factory, can be fed to and removed from a colour printing machine and/or a stamping device, by means of a computer-controlled tool. Small moulds, in contrast to large moulds, can be structured easily and cost-effectively based on digital control. Energy can be saved, due to the fact that, during the structuring process, the mould is always hot and remains hot. The structuring process only takes a few seconds. The production of the mould with a silicone or textile surface is very cost-effective and can be done within one day, in contrast to metal stamping tools or stamping rollers.

For example, the invention is explained in more detail with the help of the drawings.

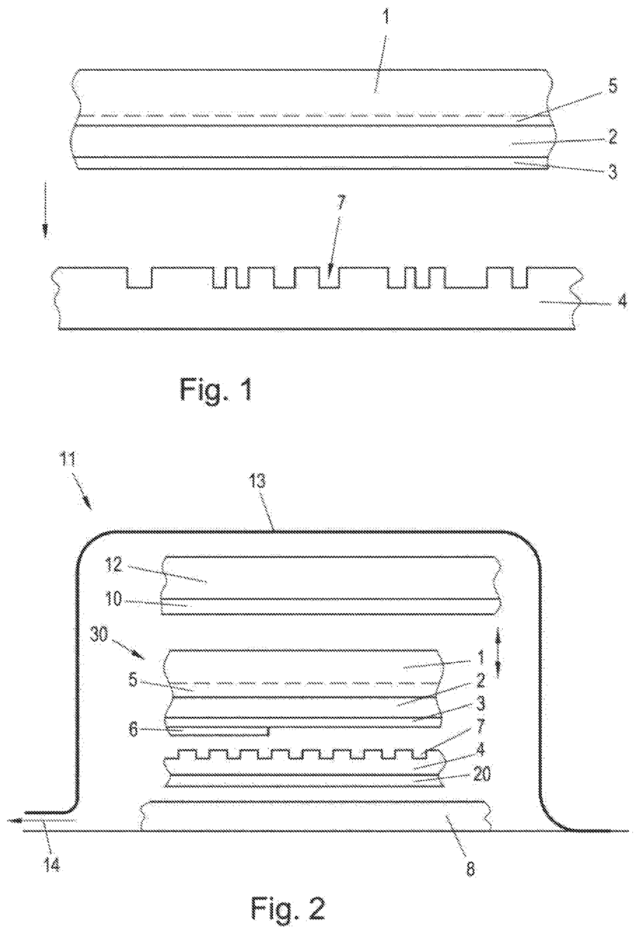

FIG. 1 schematically shows a section through a layer material, structured according to the invention. FIG. 2 schematically shows the structuring process. The layer material, according to the invention, is produced in such a manner that a layer 2 of a PU foam is bonded and applied to the surface of a backing layer 1. If the backing layer 1 is a textile fabric, this textile fabric can be provided on the surface with a layer 5 of a soft PVC or of a PU foam, made of a PU dispersion or PU dispersion mixture or of a polyacrylate dispersion, as a base layer for pre-coating, in order to be able to appropriately bond the layer 2 of PU foam to the possibly rough textile fabric. When stamping the layer 2 with the mould 4, the layer 2 is deformed, but it does not penetrate into the backing layer 1.

An additional layer 3 of a non-foamed PU dispersion or a non-foamed PU dispersion mixture is applied to the layer 2 of PU foam, before it is structured. With a mould 4, schematically shown in FIG. 1, the indicated surface structure 7 can be applied to the layer 2, and to the additional layer 3 present on top of it. The backing layer 1 and the mould 4 are pressed together, by means of appropriate moulding presses, and by means of using heating devices, e.g., infrared heaters—FIG. 2. The mould 4 can be heated to the required temperature for the stamping process, in order to bring the PU foam to the desired softening temperature. If a cold or insufficiently heated mould 4 is used, the layer 2 can be heated before its contact with the mould 4, for example, with an infrared heater.

Before stamping, the surface of layer 2 and of the additional layer 3 is smooth and even.

The use of a PU impact foam or PU foam with hollow microspheres provides an advantage over non-foamed or non-gas-containing coatings represented by the fact that the surface-structured PU foam can be compressed and deformed, when stamping under a certain temperature and pressure. Air and moisture, which are present when the layer 2 is laid on the mould 6 can dissipate, so that the stamping process is void- and bubble-free.

When the PU foam has dried, the layer material can be punched into pre-cut parts, before further processing, and the pre-cut parts are then independently subjected to stamping and surface structuring, under pressure and temperature.

The additional layer 3 can either be applied directly on the PU foam layer 2 or on the mould 4, and dried on the mould, water-free, or almost water-free, and, if necessary, pre-cross-linked, or under-crosslinked in such a manner that it can be peeled off there directly and hot and can be inseparably bonded to the layer 2 during stamping; the manner in which the layer 3 was applied is no longer visible on the stamped layer material.

During the hot drying of PU dispersions, hairline cracks and bubbles can occur, which are, however, resolved during the structuring, according to the invention, by the plasticising of the layer, in particular due to the selected pressures, and no longer occur.

The process, according to the invention, advantageously uses only non-toxic materials that can also be processed economically and safely by unskilled workers. Furthermore, the stamping of an already dried PU foam is gentle on the mould, as the cross-linking agent contained in the PU foam is no longer wet and does not come into contact with the mould, to the same extent as with conventional coatings, due to the fact that cross-linking agents act aggressively on silicone moulds, and subsequently corrode them.

When calculating the specific weight of the PU foam, one must take into account that it may contain pigments or additives, with different specific weights, depending on the intended use. For example, titanium dioxide, as a white additive for colouring, is very heavy, whereas pigments of other colours may have a much lower specific weight. If the open-cell PU foam contains hollow microspheres filled with gas, which are known to be closed cells, they must be taken into account when calculating the density by means of deduction.

The foamed and thermoplastic layer 2 of PU foam is compressed by means of heat and pressure, in order to adopt the negative structure of the mould 4. The micro-foam is thereby compressed in such a manner that a part of the microcells is lost, and the PU foam still has an open-cell micro-foam structure, but only has a weight of 0.80 to 1.05 kg/dm³. In contrast, a non-foamed compact layer, produced based on the same recipe, has a density of 1.050 to 1.120 kg/dm³. This results in an advantage in terms of weight and saved material, according to the invention. Due to the controllable compression of the PU foam during stamping, in contrast to non-foamed coatings, deeper structures can be displayed, even at low pressure, and, surprisingly, the softness is preserved.

Due to the fact that layer 2 is permeable to water vapours and air, any expanding gas or any residual water vapours, produced during hot pressing, are discharged through layer 2 into the backing layer 1 and no voids, bubbles or cracks occur. When placing the dry layer 2 on the hot mould or the mould that is to be heated, it is important that the air that expands with heat, or residual gases that cannot be released in or through the mould, can be discharged through the open-cell PU foam, or through the backing layer 1. If the layer does not have an open-cell microstructure, voids shall appear in the grain channels of the moulds, in the form of unwanted pores and shiny areas.

The thin, harder, non-foamed layer 3 is also permeable to air under pressure at the preferred thickness, so that the air contained in the grain channels of the mould 4 can also be released.

Structured surfaces by means of hot pressing are especially used for shoes, steering wheels, bags, leather goods, etc. According to the invention, format parts, e.g., with dimensions of 0.35 to 0.9 m², can be easily produced by means of stamping out sets of format parts from the used backing layer 1, with a small stamping waste. A format part can be made large enough in order to cover the upper parts of a pair of shoes, for example.

The complete PU dispersion mixture advantageously contains up to 4.2% by weight of cross-linker before foaming, in relation to the total weight of the PU dispersion mixture. Accordingly, the dried PU dispersion mixture is under-cross-linked and is and remains thermoplastically deformable. Advantageously, 8 to 25% by weight of a 40 to 50% acrylate dispersion, which can be advantageously cross-linked with isocyanate, can be added to the respective PU dispersion mixtures, in order to improve hydrolysis resistance.

If a 50% PU dispersion, i.e. 50 parts solid and 50 parts water, is applied as a film registering, for example, 0.15 mm thickness on an backing layer, this film shrinks, and collapses, respectively, by about 50%, due to water loss, when drying with the help of heat. Furthermore, when drying (e.g., in a hot drying channel) at 120° C., the film becomes cracked, due to the fact that a skin forms on the surface, which makes it difficult to remove water from the film under the skin. Drying must therefore take place slowly and at a low temperature, below 80° C., over a longer period of time, which is inefficient. The advantage of the invention is that the PU foam is not applied directly to the final backing layer, as is the case in the reversal process. Part of the water is absorbed by the backing layer and can be discharged in less than two minutes, at temperatures of 100 to 120° C., without causing cracks and voids that cannot be resolved during structuring.

The relevant PU dispersion mixture(s) contain(s) foaming aids, for the purpose of foaming and stabilising the expanded foam, in the simplest case an ammonia-containing foaming agent, in an amount of 0.5 to 2% by weight (in relation to the total weight of the relevant PU dispersion mixture with additives). Thickening agents, e.g. Acronal-based (Wesopret A2), can be added to the relevant PU dispersion, or the PU dispersion mixture, respectively, in an amount of 1 to 4 m % (in relation to the total weight of the relevant PU dispersion with additives).

The PU foam is formed by means of mixing gas, or air, respectively, with well-known stirrers, similar to the stirrers used for the production of whipped cream or beaten egg whites.

The PU dispersions used are water-based PU dispersions.

The softening point is measured, and checked, respectively, on the Kofler bench.

According to the invention, particularly good deformation properties for the design of the surface and excellent bonding between the backing layer 1 and the foamed and gas-containing layer 2, respectively, are achieved when the PU dispersion mixture contains 18 to 52% by weight of a PU dispersion in the form of a heat-activated contact adhesive or a mixture of such PU dispersions, the PU dispersions or the mixture having a content of PU solids of 40 to 50%, being heat-activated and already becoming paste-like and sticky at a temperature of 45° C. Such PU dispersions are heat-activated polyurethane-based PU dispersion contact adhesives, such as Luphen, from BASF, or KECK-DIS 779, from Keck Chemie GmbH, or Köracoll 3350, from Kömmerling Chemische Fabrik GmbH. When a cross-linking agent is added and becomes active, such as the product Aquaderm XL 80, from Lanxess AG from Köln, the softening point of such PU dispersions is shifted to higher temperatures. However, the PU dispersion mixture containing the heat-activated contact adhesive does not lose its thermoplastic properties, even if the dried, anhydrous layer 2 of PU foam has been brought to a temperature of over 110° C., preferably over 145° C., by means of heat and pressure, during the shaping of the surface. The PU foam either contains no cross-linking agent or is under-cross-linked in such a manner that its thermoplastic properties, and its thermoplastic deformability, respectively, are maintained.

A PU dispersion or several PU dispersions in the amount of 39 to 73% by weight—in relation to the total weight of the PU dispersion mixture—whose softening point is higher than 125° C., is mixed with this PU dispersion with hot-melt, and contact adhesive properties, respectively, whereby these PU dispersions or the mixture of such PU dispersions themselves do not have any hot-melt, and contact adhesive properties, respectively.

The invention also eliminates the known disadvantage according to which coatings produced with PU dispersions on hydrophobic backing layers achieve only insufficient adhesion, or bonding, respectively. A hydrophobic backing layer prevents the penetration of PU dispersion, which usually contains more than 40% water, into the surface of the backing layer. This disadvantage of PU dispersions for coating, which is well known in the leather industry, is improved, according to the invention, due to the fact that the PU foam used according to the invention behaves like a heat-activated hot-melt adhesive, after drying during structuring, and can penetrate into the finest recesses of a backing layer under pressure. The PU foam fixes itself to the backing layer like a hot melt adhesive and improves the adhesion.

In order to determine whether a PU dispersion mixture, or a PU foam produced with it is suitable for structuring, the properties required for hot stamping, such as thermoplasticity, stickiness and flow behaviour, are tested under heat and pressure. This is done in such a manner that a layer with a thickness of 1.0 mm is formed from a dried, not yet cross-linked PU foam, i.e. a layer of PU expanded foam and/or PU foam containing gas bubbles, which has a 0.02 mm non-thermoplastic, non-foamed layer, and this is placed in the hot oven or on the Kofler bench, at a temperature ranging, in particular, from 90° C. to 165° C., preferably from 110 to 150° C., in what concerns said properties. If the result is positive, this layer of PU foam is compressed in a press, with a silicone rubber mould provided with the desired surface structure, which has a Shore A hardness of 75, at temperatures of 110° C. to 165° C. and pressing times of 2 to 18 s and a pressing pressure of 4 to 48 kg/cm². At these temperatures, the PU foam film must be highly viscous and sticky, but must not be too highly fluid, and must optimally reproduce the mould and must be easy to peel off from the mould, without incurring deformation, without leading to the change of the formed structure. The above mentioned commercially available PU dispersions usually fulfil this requirement. For a skilled individual, it is easy to set an appropriate mixing ratio of such commercial PU dispersions, and to adjust different application purposes, in what concerns different surface structures and different loads, and to set or pre-set the softening and stamping temperature.

In general, silicone rubber casting compounds or silicone resins are used in order to produce the moulds, whereby the moulds have a Shore A hardness of 25 to 98. The density of the moulds is more than 1.150 g/cm³ and they are condensation- or addition-linked. The moulds produced can be engraved by means of a laser or mechanically or can be produced in a 3D printing process.

A mould for the structuring of a format part cut out of the layer material can, if this mould has been produced by means of 3D printing, also consist of a material other than a silicone polymer. In this case, the melting point of this material must be above 185° C. and, at this temperature, must still have the same hardness as at 20° C., and a hardness only deviating by a maximum of 5%. For example, epoxy and polyester resins or low-melting metal alloys can be used. It is also possible to form webs and extensions, or dents, in such moulds, in order to form capillaries in layers 2, 3, while simultaneously structuring them.

The invention is explained in more detail below, with the help of examples.

### EXAMPLE 1

The three-dimensional structure of a braiding material, consisting of 5 mm wide leather straps, with recesses between the leather straps of 0.6 to 0.9 mm, was transferred to a mould, by means of moulding with a silicone rubber compound. The mould has a thickness of 2.2 mm and a hardness of 86 Shore A and shows the precise structure in negative.

A mixture for a layer 2 was prepared, consisting of:

300 g Köracoll 3350 with a solid content of about 48% and an activation temperature of about 45° C. from Kömmerling Chemische Fabrik GmbH.
650 g Cerfan Expert Soft with a solid content of about 50%, not heat activated, from HELCOR-LEDER-TEC GmbH.
20 g cross-linking agent XL 80 from Lanxess AG.
10 g Melio Foam AX-03 from Stahl

### 5 g TS 100

5 g micro hollow spheres with a diameter of 20-40 μwhen dry
15 g thickener acrylic dispersion with about 60% of solids
30 g black pigment

After 5 minutes of stirring, the mixture had a viscosity of 45 seconds in the 8 mm diameter Ford cup.

Afterwards, 1 litre of this mixture was foamed up to 1.25 litres, by means of blowing in air.

By means of an engraved counter-rotating roller, 390 g was applied to split leather as backing layer 1.

The wet dispersion surface looked homogeneous.

Drying was carried out in a hot oven with air flow, at 105° C., in 2.5 minutes, to a water content of 0.8%. The thickness of the dried foam layer was then 0.27 mm.

The surface showed fine hairline cracks after drying but was otherwise even and free of bubbles.

On the surface of the foam layer, an additional application of a dispersion mixture was carried out, as layer 3, consisting of:

600 g Aquaderm HW2 from Lanxess AG
350 g DLV-N from Lanxess AG
25 g cross-linking agent XL 80 from Lanxess AG
100 g water
30 g black pigment
150 g delustering agent from HELLER-LEDER GmbH
15 g adhesive HW 283 from Stahl GmbH

This mixture had a viscosity of 25 seconds in the Ford cup, with a diameter of 4 mm. By means of a spray application, 70 g were applied wet, and dried at a temperature of 110° C. and air in 1 minute. The fine hairline cracks were visible. The dry layer had a thickness of 0.025 mm. After a storage time of 48 hours, shoe and bag parts were cut out of the layer material, with a flat surface and three-dimensionally structured. The silicone rubber mould, with its negative structure, had a temperature of 145° C. The mould pressure on the part to be structured was 9 kg/cm². It was maintained for 10 seconds. After that, the part was demoulded from the hot mould 4 without any effort and removed from the mould without any defects. The hairline cracks in the foam layer were closed, or removed, during the plasticising process under pressure. The three-dimensional formed surface had the same appearance and structure as the braiding material made up of leather straps. Cross-sections of the coating showed neither hairline cracks nor voids in the foam layer, at a 50-fold magnification. The finished part was still as soft after structuring as before and was only 0.02% thinner than it was before the structuring.

### EXAMPLE 2

From the same coated flat material as the one from Example 1, a format pre-cut part for a bag sized 22×28 cm was cut out and stamped three-dimensionally with a textile structure, at a temperature of 140° C. and a pressure of 8 kg/cm² and a dwell time of 7 seconds. The textile material was a patterned grid-like polyester fabric, with a thickness of 0.6 mm, and was bonded to a 1.0 mm thin aluminium plate. The three-dimensionally structured part showed the precise textile structure negatively. The peeling off of the textile mould was easy and possible without adhesives, because the thin non-foamed layer 3 matched the layer 2 and the textured textile surface, without becoming sticky.

### EXAMPLE 3

The grain side of cow grain leather was polished to 0.05 mm with 180-grit sandpaper. A PU foam with a thickness of 0.220 mm was applied to the polished side, by means of a counter-rotating roller, in order to form the layer 2. At a temperature of 110° C. and with the help of circulating air, the water content was reduced to 1.3% by weight in the course of 2.5 minutes. The PU foam only decreased in thickness by 0.06 mm in the course of drying.

The foam was prepared from 420 g of PU dispersion, with the name KECK-DIS 779, from Keck Chemie GmbH, with heat-activated contact adhesive properties, with a content of solids of approx. 40% and 480 g of polyurethane dispersion, with a high softening point of over 140° C., and without adhesive properties, with an amorphous structure, based on polyester, and a content of solids of approx. 40%, with the name DLV-N, from Lanxess AG, as well as 20 g of Meliofoam paste, 30 g of thickener, 50 g of pigment.

After drying in the hot cabinet, the PU dispersion mixture had a softening point, and range, that allowed excellent stamping at a temperature of 125° C.

This mixture had a volume of 1.07 l and was whipped, or enlarged, to a volume of 1.35 l, with a commercial foam whipping device, by means of air blowing. The foam, which had a consistency similar to whipped cream, was applied to the polished side of the grain leather with a thickness of 0.220 mm and dried. After 48 hours, the PU foam was stamped with a water content of less than 1% by weight.

The stamping was done at a mould temperature of 125° C. and a pressure of 8 kg/cm². The pressure was maintained for 11 seconds.

The structure of the backing layer, or the leather, was not visible through the foam or the layer 2. The bond, or the formation of the layer, was free of voids and bubbles; there was no sinkage.

The formation of an additional layer 3, on top of the layer 2 of PU foam, which was created as previously indicated, resulted in a water vapour permeability of 0.8 mg/cm²/h. In order to produce this additional layer 3, a layer of PU dispersion mixture, which was not foamed, was formed to a thickness of 0.020 mm, after drying of the mould 4 used for structuring. In relation to its total weight, this PU dispersion mixture was prepared with 60 g of polycarbonate-ether-based PU dispersion called Aquaderm Finish HW2, from Lanxess AG, with a content of solids of about 35% by weight. 40 g PU dispersion on polyester basis, with a solid content of 40% by weight and DLV-N, from Lanxess AG, were mixed with this. Furthermore, this PU dispersion mixture contained 1.8 g XL 80 from Lanxess AG, as a cross-linking agent, 5 g black pigment paste, 3 g polysiloxane, 1 g delustering agent TS 100 and 20 g water. A dried layer of such a PU dispersion has a Shore A hardness of over 75.

This PU dispersion mixture, with the specified additives, was applied to the mould 4, 10 minutes before the structuring process without foaming. Drying to less than 1% water content took place. The bonding of this additional layer 3 with the layer 2 of PU foam on the backing layer 1—indicated above—was carried out in the course of contacting the layer 2 with the mould 4, at the above-mentioned stamping temperature and pressure. Within the process, this additional layer 3 was inseparably bonded to the layer 2 of PU foam. This layer 3 has a Shore A hardness of 75.

The resulting high adhesion of PU dispersion-based layers with hydrophobic backing layers, in particular with hydrophobic leathers, in combination with water vapour permeability, represents a prerequisite, above all, for safety footwear belonging to class S1 and S2, and is easily fulfilled with the layer material according to the invention, depending on the thickness of layer 2.

It was also found that, when using a backing layer pre-coated with a foamed soft PVC, it is preferable to prepare the layer of PU foam only with PU dispersions based on polyester or polycarbonate. With polyether-based PU dispersions, plasticiser migration may occur in the PU foam.

The commercially available PU dispersions are used as PU dispersions for the production of the PU foam for layers 2 and 5. These commercial PU dispersions are based on aliphatic or aromatic polyester, or polyether or polycarbonate polyurethanes. Such PU dispersions have a solid content of 35 to 52. The pH value of such PU dispersions is between 6.5 and 9.5. After dehydration, or drying, the film that forms has an elongation at break of 500 to 1100%.

These PU dispersions are cross-linkable, e.g., with XL 80.

The hardness of a dried and cross-linked, non-foamed film, or of layer 3 of applicable PU dispersion mixtures, respectively, is 45 to 95 Shore A, preferably 70 to 80 Shore A. The formed layers are odourless and free of unapproved chemicals.

Very advantageously, the thin layer 3 of non-thermoplastic, non-foamed polycarbonate, based on polyether, improves wear behaviour, and the abrasion behaviour and the flexural strength of the layer 2.

A cross-linking agent was not added to the PU foam of layer 2 in the present example.

After stamping, the following values were determined for layer 2 provided with layer 3:

1. Wear resistance and abrasion din en iso 17076-1 H22 1ooox: no wear.
2. Bending din en iso 540l 125 000 flexe: no wear

### 3. Adhesion din en iso 11644: 24n

In general, silicone rubber moulding compounds or silicone resins are used in order to make the moulds, which have a Shore A hardness of 25 to 98. The density of such moulds is over 1.150 g/cm³ and these moulds are condensation- or addition-cured. The moulds can be engraved by means of a laser or mechanically.

### EXAMPLE 4

A PU dispersion mixture was prepared with:

460 g of commercial PU contact adhesive dispersion with heat-activated contact adhesive properties and with a solid content of approx. 40% by weight. 510 g of commercially available PU dispersion based on aliphatic polyether, with a solid content of 40%, with a softening point of a dried layer (0.5% by weight of water) of 155° C., and a hardness of 55 Shore A in its dried state, 40 g of black pigment paste,
2 g thickener in the form of polyacrylate,
15 g foam paste Melio Foam,
20 g cross-linking agent,
10 g polyacrylate dispersion with a solid content of 50% by weight,
5 g hollow microspheres with a diameter of 20μ

One litre of one of these PU dispersion mixtures was added to 1.25 l.

A layer of 0.25 mm was applied to a microfiber fleece, with a counter-rotating driven applicator roll, and dried to 1.0% by weight water content within 2 minutes, in a circulating air dryer, at a temperature of 115° C. After 3 hours, the layer 3, as resulting from example 3, was applied directly on this layer 2, so that the dry layer 3 has a thickness of 0.02 mm and pressed and structured at a temperature of 135° C. and a pressure of 8 kg/cm², for 15 seconds, with a surface-structured silicone mould.

Afterwards, stamped parts are thus produced. The stamped parts show in the positive the precise structure of the negative mould, which had the appearance of kangaroo leather. The layer 2 had a thickness of 0,100 mm and the adhesion between the backing layer and layer 2 was 38 N/cm.

### EXAMPLE 5

A PU foam, according to Example 2, was applied to a kangaroo leather with polished grain, by means of a roller, in a thickness of 0.24 mm, and dried at a temperature of 95° C. to 1% by weight water. Afterwards, shoe upper pre-cut parts for football shoes were stamped out and structured, as shown in example 4. A layer 3, as shown in Example 3, was applied to layer 2, by means of screen printing, in such a manner that layer 3 had a thickness of 0.018 mm, when dry. The thickness of layer 2 was 0.110 mm and the adhesion between the backing layer 1 and layer 2 was 22 N/cm.

### EXAMPLE 6

A mixture of PU dispersions, but in the colour white, containing 12 g titanium oxide, according to Example 4, was foamed, and the PU foam was applied airless to a thickness of 0.22 mm, wet, onto a microfiber fleece, in order to form the layer 2, and was dried at a temperature of 120° C. for 2 minutes, to less than 1% by weight water. The dried layer 2 has a thickness of 0.10 mm. Then shoe upper parts are stamped out. A 0.025 mm thick non-foamed PU dispersion mixture was applied to an unstructured mould, which had a thickness of 0.020 mm, when dried. The solid content of this PU dispersion mixture was 35% by weight. Furthermore, this PU dispersion contained 5% by weight red pigment paste. The stamped parts were placed on the layer 3 on the mould 4 and pressed, as described in example 2, whereby the layers 2 and 3 were inseparably joined together and the textile structure of the mould was negatively transferred to the stamped part.

### EXAMPLE 7

One backing layer of textile fabric was pre-coated with a soft PVC foam and another backing layer of textile fabric was pre-coated with PU foam, as a web material, with a thickness of 0.30 mm and a composition according to example 4, as used for the formation of a layer 2, but containing 5% by weight cross-linking agent. On each of these pre-coated backing layers, a heat-texturisable layer 2 of PU foam was applied, by means of a scraper, in a thickness of 0.15 to 0.45 mm, and dried to a water content of less than 1% by weight. A non-foamed layer 3 of a PU dispersion mixture, with a thickness of 0.035 mm, was applied to this layer 2. This PU dispersion mixture had a solid content of 35% by weight, and a content of a cross-linking agent of 3% by weight. After the drying of the layer 3, the pre-cut part, and the layers 2 and 3, were structured at a temperature of 155° C. and firmly bonded to each other and to the layer 5.

The invention is particularly advantageous for the production of format and cut-to-size parts, e.g., for shoes or steering wheels. A full-flat good connection between the relevant backing layer material 1 and the layer 2 is achieved. At the same time, a temperature resistance of up to 125° C. is achieved. The requirement according to which, up to these temperatures, a storage of 24 hours can take place, whereby the structure of the surface, its colour, as well as the degree of gloss level or an intended matteness must not change at all or not change significantly, is fulfilled. Extreme demands are made, when moulds are used, which have a surface structure obtained by means of moulding a fabric made of fabric fibres or when moulding surfaces of carbon fibre fabrics. The structure moulded onto layer 2 precisely corresponds to the mould structure, in terms of its three-dimensionality, gloss level and matteness.

A precise three-dimensional reproduction is achieved particularly well, if a thin PU dispersion in the thickness of 0.025 to 0.06 mm of a cross-linked PU dispersion, with a softening point of more than 125° C., is applied to the mould 4 or to the layer 2, before the layer 2 is applied. This PU dispersion contains polycarbonate-based polyurethanes, such as Aquaderm Finish HW2 from Lanxess AG, and/or aliphatic polyester and/or polyether, and has a hardness of more than 75 Shore A, after cross-linking. Such PU dispersion mixtures contain a solid content of 25 to 35% by weight and, as an additive, 2 to 3% by weight of cross-linking agent, up to 6% by weight of pigments, 1 to 3% by weight of polysiloxane and matting agents. This layer 3 is applied to the dried PU layer 2 in the already described manner.

Especially for layer material in the form of meter goods, in particular with a textile backing layer 1 made of woven or knitted fabric, a pre-coating with a layer 5 made of foamed soft PVC or cross-linkable PU foam or cross-linkable polyacrylate dispersion is carried out. It is advantageous to apply the foam layer 2 to the layer 5, by means of a scraper. After this layer has dried, layer 3 is applied to this layer 2, preferably with a print roller. The drying of the applied PU layer 2 and 3 is carried out on the roll-shaped backing layer 1, with the layer 5, in a continuous dryer. The three-dimensional structuring is carried out in such a manner that format parts and pre-cut parts are stamped out of the meter goods, which have the layers 5 and 2 or 3 on the backing layer 1. The layer 2 of PU foam and the non-foamed layer 3 or the format parts are brought to a temperature, in particular, of 145 to 165° C., and stamped, by means of the heated mould 4 or infrared heaters.

In the case of a backing layer 1, pre-coated with soft PVC, it is advantageous to select the temperature and/or the stamping speed and/or the pressure in such a manner that the PVC layer is at least slightly structured.

For the structuring, the PU foam should not be highly fluid, but rather pasty and easily mouldable under pressure, in order to be able to reproduce the fine structures of the mould.

An advantageous consistency of the PU foam of layer 2 occurs when the PU foam has a similar melt viscosity as soft PVC, at a temperature of 160 to 180° C., i.e., it is flowable and formable under pressure. This also applies, if an additional layer 3 is applied to layer 2, before the layer 2 is structured.

The formation of a corresponding degree of softening, or a desired deformation consistency, can be controlled by means of the quantity of the cross-linking agent used, and/or by means of the mixing ratio of PU dispersions with low, and higher softening points or softening ranges.

Delustering agents, in particular delustering agent TS100, from Evonik Degussa GmbH, used for layers 2 and 3, improve the feel of the surface, facilitate the drying process, lead to a dry feel and improve water vapour permeability.

The drying of the layer 2 takes place under heat in a dryer, or a continuous dryer.

A possible extensive drying is advantageous, preferably to the point where the material is free of water. The required temperature and the required dwell time are easy to determine empirically. Since the water content of PU dispersions, or of PU foam, is precisely known, the former can be determined, e.g., by weighing how much water has already evaporated during drying. Furthermore, the absence of water can be detected, if no disruptive water vapour evaporates during structuring.

In order to determine the water content in the dried PU dispersion, and the PU dispersion mixture, when exposed to heat, it is also possible to determine how high the residual water content is, after certain different dwell times in the drying oven. It is therefore easily possible to determine the desired residual water content, and the required temperature and residence time. The absence of water can also be achieved in this manner, or the required parameters can be determined for production. Advantageously, the water is removed completely, or almost completely.

The reduction of the thickness of the layer 2 can be considered especially for polished grain leathers and backing layer 1 made of microfiber fleece and for leather fibre materials from which format, and stamped parts for shoes and leather goods, are made, which are to be structured on the surface. When the layer 2 is compressed, the resilience, abrasion resistance and bending behaviour of the layer 2 are improved.

The structuring or the shaping of the surface by means of heat and pressure and a silicone rubber mould or a mould made of textile fabric can also be carried out in a vacuum process, i.e., under low pressure. For example, moulds with textile surfaces can be used, or the space between the core end plates can be evacuated. Such compression moulding processes using low pressure, or vacuum, are known.

When structuring the PU foam, or the layer 2, it is possible, according to the invention, to place reinforcing and/or moulding parts for the layer material on the mould 4 and/or on the layer 2. During the compression moulding process, which takes place under pressure and at an elevated temperature, these parts are firmly bonded to the layer 2 and the layer 3. These reinforcement or moulded parts can be of any shape, and can have the form of stripes, circles, stars, geometric or other figures, etc. Plastic films that bond with the layer 3, especially those made of thermoplastic PUR, can be deemed as materials.

The contact adhesive Köracoll 3350 from Kömmerling Chemische Fabrik GmbH, Germany, and the adhesive DIS Type 779 from Jakob KECK Chemie GmbH, Germany, can also be used as a PU dispersion with heat-activated hot-melt properties, for the production of the PU dispersion mixture.

Due to the permanent thermoplasticity of the layer 2 and the thin thickness of the layer 3, a stamping of the layer material, especially stamped parts, can be carried out, even after a longer storage period, e.g., 6 months, without incurring any loss of quality.

According to the invention, it is advantageous if pre-cut parts are formed, or stamped out, from the coated backing layer 1 and these pre-cut parts are subjected to the stamping, or structuring process, if necessary, after a temporary storage. These pre-cut parts have a flat two-dimensional surface that can be deformed accordingly during structuring, and then a three-dimensional structure.

It is possible to print with the desired colour on the flat two-dimensional surface of the format pre-cuts or pre-cuts or stamped parts 30 on the layer 3, e.g., in a shoe factory, before structuring, or to print colour overlays, foils 6 with motifs or colour foils and, thus, to colour the layer 3 for format parts, or to provide them with motifs. The application of colours can, for example, be carried out using the Panton or screen-printing process. After the colour imprints have dried, the stamping process can be started, in order to build three-dimensionality. These printed colour layers preferably have a similar composition to the layer 3.

For structuring, it is advantageous, if the mould made of silicone rubber material or silicone resin has a Shore A hardness of 25 to 98. This means that the mould is pressure-elastic and can compensate for any unevenness, which may occur in the backing layer 1, if it is a natural material, such as leather. The same applies to moulds with a textile surface, especially if the textile surface has a thickness of more than 0.5 mm. The silicone rubber moulds and the moulds with textile surfaces can be supported by a heatable metal substrate 20 and can be heated to the temperature required for the structuring process.

It has been found to be advantageous, if, between the backing layer 1 of the stamped part 30 and the compression moulding plate 12, i.e., a metal plate of the press used for the structuring process, a compression elastomeric base part 10 is inserted, which has a thickness of about 1 to 8 mm, preferably 2 to 6 mm, has a foamed structure and a Shore A hardness comparable to the Shore A hardness of the silicone rubber mould 4. This allows for thickness variations in the backing layer 1 to be fully compensated, so that the stamped part, or the stamped part as a whole, has the same stamping structure throughout. Furthermore, any partial hardening of the backing layer 1 is completely excluded, even though the thickness of the backing layer 1 may vary by 5 to 10%. Such base parts 10 on the pressure-elastic material can also be arranged between the mould 4 and the metal plate 20 or instead of the metal plate 20.

It is also possible to use Astacin Finish PS, from BASF, for the PU coating dispersions used in layer 2, which do not yet exhibit any adhesiveness or adhesive properties at 125° C. For the thin layer 3, the product Aquaderm Finish HW2, from Lanxess AG, has proven to be very advantageous.

It is of economic importance that the procedure, according to the invention, can save large quantities of material, since the shoe and leather industry is supplied with pre-cut parts or stamped parts, which are cut or stamped out of the layer material, and can be printed themselves with the desired colour and/or the desired degree of gloss and/or the desired pattern. It is therefore no longer necessary to keep in stock extensive quantities of leather skins and minimum quantities per colour, as well as pre-cut goods, and, as such, large quantities of waste material for the production of pre-cut and stamped parts; instead, only the pre-cut parts already required for the stamping process are stored, which can then be colour-printed, structured and, at the same time, provided with a logo and a brand, at the product manufacturer's premises.

Even if the layer 2 is not cross-linked or under-cross-linked and the layer 3 is fully cross-linked or under-cross-linked, a strong, inseparable bond is formed between the layers 2, 3. The layer 2 remains thermoplastic and the additional layer 3, which is thinner and harder than the layer 2 and may not be thermoplastic, cannot be separated after a three-dimensional structuring has taken place, but can be stamped several times, or additionally structured with other stampings.

FIG. 2 schematically shows a device for structuring pre-cut parts 30. The pre-cut part 30 comprises a backing layer 1 and a layer 5, if present, which is advantageously formed on a structured fabric. The layer 2 is applied to the backing layer 1, and the additional layer 3 is applied to this layer 2. A finishing layer 6 applied to the layer 3 can be a coloured layer or a coloured or colour-patterned film, which has approximately the same thickness as the layer 3. The finishing layer 6 can also be, for example, a printed or sprayed leather colour.

For structuring, a stamped part or the pre-cut part 30 is applied to the mould 4 with its surface structure 7.

The mould 4 rests on a heatable base, or temperature-controllable base, or a metal plate 8, which can be heated with a heating unit that is not shown. Between the heading tool 12 and the backing layer 1 lays the insert 10, and the base 10, made of elastomeric material, which is supported by the heading tool 12. This elastomeric material is used to compensate for any unevenness in the backing layer 1, which is a natural product.

13 indicates an airtight casing of the press unit 11, which can be evacuated via an outlet 14, shown schematically, in order to be able to remove air bubbles from the pre-cut part 30, or from the space between the pre-cut part 30 and the mould 4.

The colour layer, or finishing layer 6, is always applied to the additional layer 3 before structuring and takes on the same structure as the layer 3. This means that the colour and/or the gloss level and/or the stamping can be individually controlled for individual pre-cut parts. This makes individual production possible, requiring only a few metres of layer material. Currently, the production, or the purchase, respectively, of several hundred metres of layer material is necessary for custom-made products. This makes it possible to achieve high savings, and to minimise the waste of resources.

In order to prevent or impede counterfeiting or imitation of products and brands, symbols and/or brands and/or marks can be formed in the silicone rubber mould 4, which are irremovably applied to the stamped part, and the pre-cut part, respectively, during structuring.

A protection against copying can also be achieved, if the additional layer 3 and/or any colour print applied to this layer 3 deviates in colour from the colour of layer 2. Furthermore, the additional layer 3 and/or the colour print can be removed by means of a laser, in particular, pixel by pixel, so that the colour of the layer 2 becomes visible. In the course of laser processing, continuous capillaries can also be formed in the layers 2, 3, whereby the water vapour permeability of the layer material, and of a region of the produced object, respectively, which was created with the stamped part, can be adjusted to a desired value.

The backing layer 1 is not visible through the PU foam of layer 2 and, as such, different backing layers can be given the same appearance by the same structuring of the surface of the layers 2, 3.

The PU dispersions are all aqueous dispersions.

In order to form the PU dispersion mixture, one or more PU dispersions with hot-melt, and contact adhesive properties, respectively, and one or more PU dispersions without such properties can be used, and mixed, respectively.

The PU dispersions with heat-activated properties are made of aliphatic polyurethane, based on polyether or polyester, and may also contain adhesive resins. The PU dispersions have a pH value of 6 to 9 and are miscible with each other.

The PU dispersion mixture has a pH value of 6 to 9 in the non-crosslinked state and an elongation at break of 550 to 1100% in dried or solidified form, respectively. The hardness is between 28 and 75 Shore A.

The non-thermoplastic PU dispersions are composed of aliphatic polyester, polyether, polyurethane or polycarbonate-polyurethanes. They are also fully miscible with each other. However, they have no adhesive properties between 95 and 125° C., as a rule. Similar to the heat-activated PU dispersions, they generally have a solid content of 35 to 52% by weight.

A mixing recipe for layer 2 for a PU dispersion mixture preferably contains one to three PU dispersions with heat-activated adhesive properties, and one to four PU dispersions with different hardness, without adhesive properties. According to the invention, the properties of the layer 2, such as hardness, density, thermal stamping ability, adhesive properties, softness, fatigue bending behaviour, hydrolysis resistance, as well as the bonding of layers to each other, can thus be optimally adapted to the relevant designated use.

The layer 2, which is advantageously thermoplastic and can thusly be stamped, regardless of time, offers considerable technical advantages, in terms of production.

The combination of the layers 2 and 3 is important and in line with the invention. The layer 2 is thermoplastic and, as such, only insufficiently abrasion-resistant, when exposed to heat and, also, has an insufficient resistance to MEK or isopropanol. This disadvantage is compensated by the layer 3, which is composed of polyether, polyester, preferably polycarbonate polyurethane, such as HW2, and can contain between 2 and 5% by weight of cross-linking agent or be fully cross-linked. In case the limit of 4.2% by weight of cross-linking agent is exceeded, the layer 3 is no longer thermoplastic. Surprisingly, a cross-linked layer 3 constitutes no obstacle for stamping, although it is not thermoplastic, due to the fact that, thanks to its reduced thickness, it will fully adapt to the surface shape given to the thicker layer 2 during structuring and will fully adopt the structures of the mould 4.

The heat abrasion resistance shows no damage at an ambient temperature of 50° C., based on DIN EN ISO 17076-1 H18 1000 g 500×.

When 1 g of MEK was applied to layer 3, which was inseparable from layer 2, under normal ambient conditions, and on a surface area of 100×100 mm, this quantity evaporated in 3 min, without damaging the surface. The same quantity of MEK, applied directly to a layer 2, under the same conditions, showed that the MEK penetrated into the layer 2 and caused strong swelling, which, however, reappeared after evaporation. By means of combining layers 2 and 3, the property of the thermoplastic layer 2 is used, and the disadvantages of a thermoplastic layer, as compared to chemical solvents, are avoided by the layer 3, even if it is not thermoplastic.

The layer 3 is 0.015 to 0.060 mm thick and is always made thinner and harder than the layer 2. The layer 3 consists of a PU dispersion mixture, which is preferably composed of more than 45% by weight of polycarbonate-polyurethane.

In order for the layer 3 to subordinate itself to the thermoplastic layer 2 during structuring, regardless of its degree of cross-linking and hardness, it is important for it to always be much thinner than the layer 2 and for it not to become adhesive, even at temperatures of 125 to 165° C.

The thicknesses indicated for layers 2, 3 applies to dry layers.

When applying, enough PU dispersion must be applied, in order to ensure a thickness of the layer 2 of 0.075 to 0.45 mm after drying. The layer 3 has a thickness of 0.015 to 0.060 mm; this thickness is also always to be interpreted as referring to a dry state.

Important critical points, namely the adhesion between the backing layer and the layer 2, as well as wear resistance, abrasion and fatigue bending behaviour, were investigated, as well as how the material behaves at elevated temperatures, e.g., 50° C., in practice, as compared to normal temperatures, e.g., 22° C., and what happens when the solvent, e.g. MEK or isopropanol, reaches the surface.

The adhesion of the coating was tested according to DIN EN ISO 11644. No changes were determined between the normal temperature and an ambient temperature of 50° C. The layer material tested at 50° C. had about 6% higher values than the layer material tested at normal temperature. Polished kangaroo leather was used as backing layer 1. All results were above the nominal value of 12 N.

The wear resistance, and abrasion, respectively, was tested in the Taber, according to DIN EN ISO 17076-1, at a normal temperature and at 50° C., namely with the friction wheel H22, 1 kg, >1,000 cycles. After 500 cycles, all test bodies were in order and the standard test was fulfilled.

The fatigue bending behaviour was tested according to DIN EN ISO 5402, at 50° C. After 100,000 cycles, all test bodies were still in good condition.

The characteristic “fully cross-linked” is understood to mean that the PU material has no thermoplastic properties, and, when heated, usually reaches its destruction point, before reaching its melting point. The term “fully cross-linked PU dispersions” is meant here to refer to the fact that 1 kg of PU dispersion, with a solid content of e.g., 40%, shall receive an addition of at least 5% isocyanate cross-linking agent XL, so that a complete cross-linking takes place. The products cross-linked in this manner are insoluble in, e.g., MEK or isopropanol, but may swell slightly, due to the absorption of these solvents. The thermoplastic foamed or gas-bubble containing, cross-linker-free or low-cross-linker layer 2, provided according to the invention, absorbs MEK like a sponge, due to its foam structure, then swells and becomes adhesive. In combination with the additional layer 3, in particular if this has a high content of polyether-based polycarbonate, such as, e.g., Aquaderm Finish HW2, from Lanxess AG, the thin additional layer 3 prevents swelling and loosening of the layer 2, although it also contains only 2 to 4% cross-linking agent. If, for example, 1 g MEK is applied to a surface of 100×100 mm, the surface does not swell or does not swell to a great extent. After evaporation, the stamping shows the previous grain structure once more. Only a slight shine remains. Acetone behaves similarly. Isopropanol does not lead to any loosening, swelling or shining of the surface.

If the layer 2 is to have a softness of less than 55 Shore A, it is possible, within the scope of the invention, to add 5 to 20% by weight of the total mixture of a soft PU dispersion called Epotal FLX 3621, from BASF, to the total PU dispersion mixture. This PU dispersion Epotal FLX 3621 has a hardness of less than 28 Shore A, after solidification. The added quantity is deducted from the non-thermoplastic PU dispersions.

Advantageously, the structured silicone rubber layer of the mould 4 can be connected to a metal plate 20, preferably an aluminium plate. Furthermore, it is advantageous, if a polyester-based textile fabric, with a surface weight of 30 to 150 g/m² is embedded in the silicone rubber material, on the back side of the silicone rubber, or of the mould, respectively, in order to prevent the thermal expansion of the silicone rubber. The same applies to a mould with a textile surface. Advantageously, the silicone rubber with the embedded textile fabric has a thickness of 0.6 to 2.5 mm. By means of connecting the mould 4 to the metal plate 20, the heat transfer from the heating plate 8 via the metal plate 20 to the silicone rubber of the mould 4 is facilitated. This aluminium plate, if provided, has a thickness of 0.8 to 10.0 mm. It may have mandrel-like webs 19, up to about 2.8 mm long. The space, and the distances between the webs, and the mandrels 19, respectively, can be filled with silicone rubber, which carries the stamping pattern, in such a manner that, during stamping, the tips protruding from the silicone rubber penetrate the layer 3 and the layer 2 and leave visible recesses in the layer material during peeling.

During structuring, these mandrels, and webs 19, respectively, penetrate through layers 2 and 3, and advantageously penetrate the backing layer 1, by a maximum of 0.4 mm. This improves the breathability of the layer material, without significantly weakening the backing layer 1.

The webs, and the mandrels, respectively, can have a round cross-section, but also any other shape. The distance between the individual webs is 4 to 12 mm.

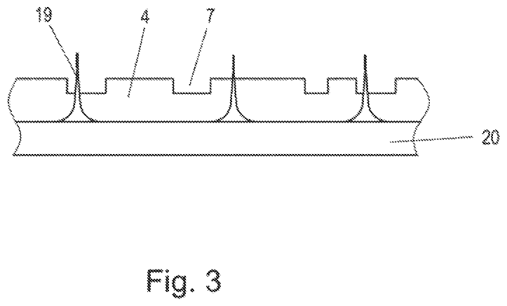

The metal plates with the mandrels, and webs 19, respectively, can be prefabricated. The thickness of the silicone rubber mould or the textile mould can determine the depth to which the webs penetrate the layers 2, 3, and the backing layer 1, respectively. FIG. 3 schematically shows such a mould 4, which is penetrated by webs, protrusions and tips 19, respectively.

If the part to be stamped is to be provided with a textile structure, the spaces between the mandrel-like webs 19 can also be covered, or filled, respectively, with a textile material providing the stamping pattern as any surface structure. During stamping, the recesses and a surface with a textile appearance are created. In this case, textile material is used instead of the structured silicone rubber material. Instead of silicone rubber material, the plate 20 carries a temperature-resistant structure or a temperature-resistant textile fabric, from which the surface is moulded. Other materials may also be used.

The invention refers not only to a process for the production of a surface-structured layer material, but also to a process for the structuring of format parts, produced or cut out or stamped out from the layer material, according to the invention. In this case, the layer material is in the form of stamped or format parts.

A particular advantage of the invention results when not the layer material itself, but the manufactured format and stamped parts made from it, are stamped.

Due to their layer structure and the PU dispersions used for the PU foam and the consistency of the expanded foam obtained, it is advantageous, in a preferred embodiment of the invention, if the format and stamped parts are loaded and stamped during the structuring process, by means of a pressure-elastic base 10, which is at least as large as the part to be structured, and which rests on, or against, the layer 1 or its rear side. This not only results in pressure equalisation, in the event of strong fluctuations in the layer 1, but also ensures that the PU foam can be fully pressed into the pre-cut part to be structured, and structured in the recesses of the structuring mould, which are up to 1.1 mm deep. The pressure-elastic material 10 is advantageously attached to the plunger 12, in the form of a pressure plate. However, it can also be placed on the layer 1, when the stamped part is inserted into the press, or placed on the flat press surface. The pressure elastic material must be compressible by more than 4%, at a pressure of 10 kg/cm², and should have a thickness of 1.5 to 12 mm. It should also withstand temperatures of at least 125° C. and recover in less than 4 seconds after pressure is released. The pressure elastic material 10 may be applied in one or more layers. For example, it can be formed from an elastomeric foam, e.g., chloroprene or silicone rubber.

The pressure-elastic material 10 can also consist of a non-woven material, with a thickness of 0.5 to 1.5 mm, coated with a very soft layer of silicone rubber, with a Shore A hardness ranging between 20 and 55. Elastomer-impregnated non-woven materials, e.g., polyester fibres or felt, can also be used, and they are impregnated with silicone rubber and subsequently have a density ranging between 0.32 and 0.89 g/cm³. Such impregnated materials have proven to be effective, due to the fact that moisture that develops during the structuring process, or the existing gases, can penetrate into these materials and be removed. Furthermore, such materials do not stick to the backing layer 1 during the structuring process, due to their silicone lining. The use of a pressure-elastic base part 10 has a significant positive influence on the quality of the stamping.

The textile fabric used for the backing layer 1 can also be a material made up of cellulose fibres, e.g., a material called TEXON, with a thickness ranging between 0.8 and 2.8 mm.

TEXON is a cellulose fibre material that is produced by the company Texon Mockmuhl GmbH in Mockmphl, Germany, among others.

A fissile foam made of EVA (ethylene vinyl acetate copolymer), with a thickness of 1.0 to 6 mm, and a density of 0.15 to 0.65 g/cm³, can also be used for the backing layer 1. These two materials can be used advantageously as a substrate, or as a backing layer 1.

Furthermore, a material made from coated leather fibre stamping waste can be used as a backing layer 1. Such a recycled product is manufactured, among others, by the company Ledertech Deutschland GmbH in Bopfingen, Germany.

Depending on the subsequent purpose of the pre-cut parts, both types of backing layers mentioned above present advantages. Such layers 1 also support the stamping ability, or the stamping behaviour of the PU expanded foam.

According to the invention, it can be advantageous, if the die plate can also be heated, in particular in a controlled manner.

When structuring a format or stamped part, it is advantageous to bond a lining material, or a layer or sheet of 0.1 to 0.3 mm thick PUR film forming a lining material, to the back of the backing layer 1, over its entire surface, or only in certain positions, as reinforcement.

The metal plate 20 supporting the mould 4 can advantageously have a higher temperature than the mould 4 itself. This facilitates the adjustment of the temperature of the backing layer.

In order to optimise the pressure-elastic properties of the plunger—depending on the material to be stamped—for the structuring, it is advantageous, if the structuring mould 4 is made of silicone rubber. In the case of such moulds 4 made of silicone rubber, it can be advantageous for the stamping process, if silicone rubber moulds are used, which contain hollow microspheres, or which are made of a silicone rubber foam. In this case, the density of the silicone rubber moulds containing the hollow microspheres can be 12 to 25% lower than the density of moulds made of silicone rubber without hollow microspheres. Also, the silicone rubber adhesive used to bond the silicone rubber moulds to the metal plate 20 of the plunger may contain 10 to 25% by weight of thermoplastic hollow microspheres. This improves the pressure elasticity, especially in the case of moulds 4 with a textile surface.

When using textile materials for moulds 4, the gases produced during the structuring process can dissipate over the mould 4, which has a textile surface, and, in particular, air and moisture can be discharged laterally from the moulds. For the three-dimensional formation of the structured surface and in order to compensate for differences in the thickness of the backing layer, it is of particular advantage, if the stamp carries a pressure-elastic base part 10.

When producing expanded foam, gas, in particular air or nitrogen, is introduced into the PU dispersions. Hollow microspheres also contain a gas in their hollow core, for example isobutane. Injecting gas and/or adding hollow microspheres always results in foam containing gas bubbles, which have fully comparable properties. A PU impact foam is equivalent to foam produced with hollow microspheres. According to the invention, foams with hollow microspheres, which have the same density, viscosity, etc., or the same stamping parameters as the expanded polyurethane foams, can be used.

However, it is also possible to produce or use PU foam by means of adding hollow microspheres to the PU dispersion mixture and also by means of injecting gas.

As such, the layer 2 has a foam structure that is obtained by means of stirring and/or adding hollow microspheres. The essential other parameters for the structure of the layer material do not change. For example, microencapsulated gas, i.e., gas-containing hollow microspheres, is added to one litre of the PU dispersion mixtures for the layer 2, whereby the hollow microspheres form closed cells. Since closed gas cells are also formed when gas is stirred into the PU foam, the foam structure is comparable. The gas bubbles produced by hollow microspheres have a diameter of about 20 to 50μ. Their shell is made of thermoplastic. They are moist before addition and have a bulk density of 32 to 39 kg/m³.

An example of layer 2 is given below:

A mixture of

300 g Luphen DOS 3575, from BASF
450 g PIS 779, from Keck Chemie GmbH
950 g Aquacast S, from Lanxess
50 g cross-linking agent XL 80, from Lanxess
50 g black pigment paste
25 g thickener Desopret A2, from Weserland Chemie
15 g delustering agent TS100
is mixed and stirred for 5 minutes. One litre of this dispersion weighs 1050 g. 45 g of hollow microspheres, with a diameter of 20 to 35μ, are then stirred into one litre of this mixture. 1000 cm³ of this mixture have a resulting volume of 1210 cm³. Using a counter-rotating applicator roll, 195 g/m² was applied to an insole material called TEXON, and 220 g/m² to microfiber fleece, and dried to a water content of about 1% by weight. The dry layer 2 had a thickness of 0.12 mm for TEXON, and 0.135 mm for the microfiber fleece.

Thereafter, 50 g of a dispersion mixture, as indicated in the example 3 for layer 3, was applied, by means of a synchronising roller, and dried to a water content of less than 1% by weight. From the TEXON material coated in this manner, insoles for sandals were stamped out and structured with a textile mould, from which needles, with a length of 0.4 mm, protruded, or stuck up, for the formation of perforations. The structuring of the pre-cut parts was carried out between a pressure-elastic base part 10, resting on the textile backing layer 1 of the pre-cut part 30, at a stamping time of 10 seconds, and a temperature of 130° C., and a pressure of 13 kg/cm². The mould 4 was precisely structured, with visible capillaries. The stamped part, which was impermeable to water vapours before the structuring, had a water vapour permeability of 1.1 mg/cm²/h after the structuring and perforation with the needles.

A shoe upper part was cut out of the coated microfiber fleece and structured and provided with visible capillaries, by means of a silicone rubber mould 4, with a negative Nappa leather structure and a Shore A hardness of 85, from which 0.45 mm long needles 19 protruded. The pressure elastic layer 10 consisted of a foamed silicone rubber, with a density of 75 g/cm³. The stamping pressure was 17 kg/cm² and the stamping time was 9 seconds, at a temperature of 140° C. After the structuring and formation of the capillaries, the water vapour permeability was 0.9 mg/cm²/h.

In these two cases, the base part 10 was inserted between the plunger 12 and the stamped part 30, and the mould 4 and the heating plate 8, or the base plate 20. As shown in FIG. 2, the pressure-elastic layer, and the base part 10, can also be connected, e.g., glued, to the plunger 12.

The hollow microspheres used in order to create the PU foam containing gas cells are known as Expancel. This company sells the 551WE40 and 551WE20 variants. The manufacturer is the company Akso-Nobel in Sweden.

It is also possible to insert a cushion filled with gas or a liquid, as a pressure-elastic material, or as a base part 10, between the mould 4 and the plunger 12 or to arrange it on the pressing support and to place the stamped part 30 on it. In this manner, when the press is closed, a pressure equalisation is achieved throughout the surface of the format pre-cut or stamped part 30, and the mould 4 exerts the same pressure on the stamped part 30 in every position.

The pressure-elastic base part 10, made of foamed silicone rubber, is compressed more strongly on the grain ends, while the base part 10 is compressed less strongly in the grain channels. A compression-elastic base part, e.g., made of silicone rubber foam, can thus be compressed, and presses the pre-cut or stamped part into the recesses of the mould. Thereby, any resulting moisture and existing air, which expands when warm, cannot dissipate through the mould, but can be discharged through the lateral edges of the stamped part.

The mould in this case is made of silicone rubber, with a hardness of 85 Shore A.

It is advantageous for certain applications to use cellulose fibre material as a backing layer, such as the product TEXON, with a thickness of 0.8 to 2.5 mm. EVA expanded foams, with a density of 0.2 to 0.55 g/cm³, and a thickness of 1.2 to 4.5 mm, can also be used.

The backing layer 1 can have a plastic coating on its reverse side, serving as a lining, with a thickness between 0.10 and 0.5 mm.

Advantages in terms of sustainability arise when accumulating leather stamping waste is reduced in size and solidified, by means of plastic material, into plates and web material, by means of heat and pressure, and used as a backing layer 1.

Alternatively, a cushion filled with gas or a liquid could equalise the pressure when closing the press or distribute it evenly throughout the surface of the pre-cut part 30, or press the pre-cut part 30 against the mould 4.

The pressure-elastic material, or the base part, can easily deform and follow the shape given to the backing layer 1 during stamping. This equalises the pressure throughout the surface of the pre-cut part 30, whereby the layer 2, with the additional layer 3, is pressed against the surface of the mould 4, e.g., made of silicone rubber, with a hardness of 25-98 Shore A. Simultaneously, any unevenness of the surface of the backing layer 1 is levelled, or recesses, such as grain dents, are filled. In the area of the grain ends, the PU foam of layer 2 is densified, and the PU foam is pressed away in the direction of the recesses or grain dents.

The formation of cracks can be reduced, if delustering agents, such as TS 100, are used or used alongside other materials. Even with a layer thickness of 0.25 mm and a drying temperature of 120° C., no cracks or no non-curable cracks occur during drying.

Furthermore, a compact PU material cannot easily be stamped at the low temperatures specified in the invention, since the material is densified during stamping, and, as such, must be able to flow. Here, the PU foam, which is easily deformable at the applied pressures and, after softening, at the temperatures specified according to the invention, is easily mouldable and contains gas bubbles, poses considerable advantages.

During hot stamping, or structuring, the mould 4 can advantageously be placed at the bottom, and the layer material, with the layer 2 of PU foam, is placed or arranged on it, facing downwards. However, the mould 4 can also be placed on the stamped part 30 from above.

The layer 2 behaves thermoplastic at the time of surface shaping, and becomes plastic under pressure and heat, so that it also moulds, or forms, the finest microstructures of the mould surface in the layer 3, if it is not thermoplastic to begin with. Nevertheless, the backing layer 1 with the structured layers 2, 3 can be removed from the mould 4 immediately after stamping, i.e., while the layers 2, 3 are still hot.

It can also be advantageous, if the layer 2 and the additional layer 3 are applied to pre-cut parts or stamped parts that have been shaped. Depending on the application, it may be advantageous to use backing layers 1 that are already coated with PU foam 2 and layer 3, which are either in the form of flat parts of a predetermined shape or dimension, or as coated hides or leather, and can be structured at a predetermined time and then stamped or shaped into the desired form. The shaping of the backing layer 1 can thus take place before or after structuring.

The stamping pressure required for structuring can be applied with a plunger 12. Part of the required stamping pressure can also be applied by means of deep-drawing or evacuation of the space between the pre-cut part 30 and the mould 4. For this purpose, a pressure diaphragm can be placed above the pre-cut part 30 and the mould 4, and the space between the pressure diaphragm and a bearing surface for the mould 4, or the space below the diaphragm, is evacuated. Furthermore, pressure pads 39, which can be pressurised with gas or fluids, can be arranged or formed below and/or above the mould 4 or the pre-cut part 30 and/or below the plunger 12.

When structuring larger pieces on moulds 4 that are not air-permeable, and, also, in the case that gases or the air between the mould 4 and the additional layer 3 cannot be discharged, either upwards or downwards, during structuring, a solution is found by means of using mould surfaces made of textiles or metallic fibres and/or threads. The gases can be discharged through the mould surface, especially laterally. This way, even large parts, such as cowhide or goatskin, can be structured. It has also been shown that moulds 4, which are not air-permeable, but are provided with mandrels or needles 19, surprisingly produce good results, even with large parts or pieces, because the mandrels 19, which penetrate the layers 2 and 3, allow the expanding air to penetrate and be discharged into the backing layer 1.

It is also possible to use a plastic-coated paper, with a structured surface, as mould 4. Such a paper is of interest if areas between the mandrels 19 are to be structured. The paper carries a thin coating of silicone resin with the stamping pattern and is placed on the additional layer 3. During structuring, the mandrels 19 carried by a compression moulding plate or plunger placed on the mould 4 made of paper penetrate through the mould paper through layers 2 and 3, to a maximum depth of 0.65 mm into the backing layer 1 or the leather, respectively. This way, a controlled and controllable water vapour permeability can be achieved by means of the perforations formed by the mandrels 19.

Air-permeable moulds 4 are particularly advantageous for larger format parts, especially those made of leather, e.g., half cowhides or goatskins, or for board formats, up to 3.5 m². With these air-permeable moulds 4, the air can be discharged laterally from the moulds 4 during structuring, if the surface of the mould 4 consists of textile fibres or monofilaments made of plastic or metal, for example.

In principle, when stamping or structuring coated leathers or artificial leathers, the surface is densified, so that previously existing water vapour permeability is at least partially, if mostly completely, lost. Surprisingly, the structural stamping, according to the invention, in which not only the structure, but also the continuous capillaries are formed in layers 2 and 3, which appear like a partial perforation, due to the fact that they do not penetrate or do not penetrate significantly into the backing layer 1, enables a precise, pre-determinable water vapour permeability.

It is of particular advantage the fact that, when structuring with moulds 4 that are not permeable to water vapour and air, the moisture and the expanding air can be removed through the partial perforation that forms and is formed into or through the backing layer 1.

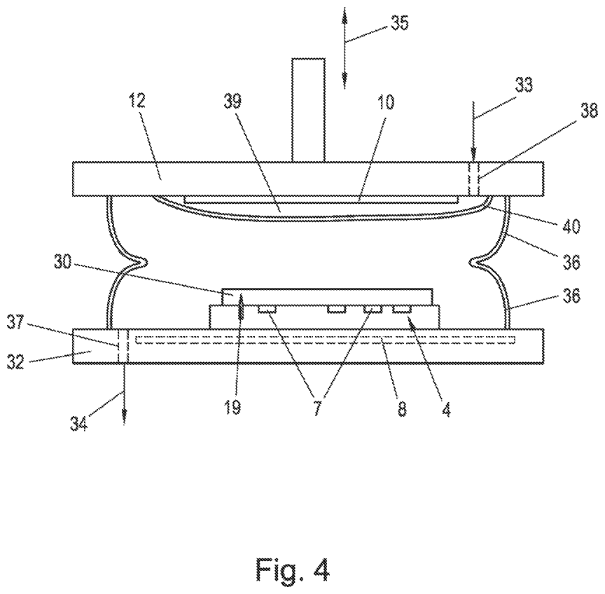

FIG. 4 schematically shows the structuring process with a discharge of gases produced in the course of structuring. FIG. 4 shows a stamping installation, which can be advantageously used in practice for structuring layer materials, according to the invention, with a comparable function, as shown in FIG. 2. These layer materials are in a fragmented, not too large form. According to the invention, mainly fragmented pre-cut parts 30 of limited size are to be structured or processed. Such parts can be pre-stamped coated or uncoated, or they can be structured and, after the structuring process, brought to the desired size or processed into stamped parts.

The press comprises a plunger 12, which can be moved up and down, in the direction of the pre-cut part 30. The plunger 12 is adjustable in relation to a support or a lower compression moulding plate 32 of a press table. The press table carries, in particular, a heating device 8 inside it. The piece to be structured or a pre-cut part 30 is placed on the mould 4.

The stamping area is surrounded on all sides by seals 36, which close off the space between the underside of the plunger 12 and the surface of the support or the compression moulding plate 32, when the plunger 12 is removed, so that air can be evacuated in the direction of the arrow 34, via a recess 37, which is formed in the compression moulding plate 32. This also allows the gases to be discharged from the part 30 that is to be machined, during the structuring process.

For structuring, the pre-cut part 30 is loaded with a predetermined force. This force can, for example, be the atmospheric pressure, when, as in a deep-drawing process, the air present between the plunger 12 and the compression moulding plate 32 is extracted. If the plunger 12 is moved to its lowest position and locked, additional or alternative pressure can be applied to the pre-cut part 30 that is to be processed, by means of introducing a pressure medium, according to arrow 33, through a recess 38 in the plunger 12, into a space 39 between the plunger or the stamping part 12 and a pressure diaphragm 40. For this purpose, it is necessary to fix the position of the plunger 12 in relation to the compression moulding plate 32 in advance.

In addition to or instead of applying pressure by means of deep-drawing or by means of the pressure diaphragm 40, it is, of course, provided that the plunger 12 itself can apply the necessary stamping force.

Any pressure fluid can be used to pressurise the pressure diaphragm 40.

The advantage of such a stamping installation is that the pressure diaphragm 40 distributes the pressure evenly throughout the surface of the mould 4, or of the pre-cut part 30 that is to be machined, so that it is possible to compensate for any unevenness in the surface of the part 30 that faces the mould 4.

Another advantage of this arrangement is that any resulting gases can be discharged laterally from the mould 4 and/or the piece 30 that is to be structured, and subsequently removed through the opening 37.

The pressure-elastic base part 10 on the plunger 12 is provided optionally.

The formation of capillaries in a polymer coating, in order to achieve the desired water vapour permeability is notoriously difficult, i.e., water vapour permeability is not controllable. Expanded foams and coagulated foams vary greatly in terms of water vapour permeability, depending on their density and the applied finishing, especially when the leathers have been stamped with a pressure of over 60 kg/cm².

It is the task of the invention to provide not only stamped parts of a smaller format, but also fragmented parts of a larger format, such as cowhide skins, with a desired or adjustable breathability, by means of an easily controllable and economical process. This is achieved by means of mandrels or spikes, which form perforations when structuring the layer material in layer 2 and in the additional layer 3, respectively. These layers 2, 3 are penetrated; the formed perforations do not continue significantly into the backing layer. The mandrels or spikes 19 penetrate the backing layer up to a maximum of 0.65 mm, but do not weaken it. This allows format parts, such as cowhide skins, to be economically structured and, if necessary, also partially perforated afterwards; also, a desired number of capillaries per flat unit can be formed in a targeted manner.

The perforations are made with a plate or mould, from which up to 2.8 mm long pointed needles or mandrels 19 protrude. The tips or mandrels 19 have a shank diameter ranging between 0.6 and 2.6 mm. They are arranged in a number of 2 to 10 pieces per cm². The mandrels protrude from the structuring material of the mould 4, e.g., textile material, silicone rubber or structured coated paper, and penetrate into the mould 4, when the mould 4 and the pre-cut part 30 come into contact. The mandrels 19 advantageously protrude from the mould or the structuring material of the mould, by a maximum of 1.6 mm, and advantageously penetrate the backing layer 1 by a maximum of 0.25 mm.

The structuring and simultaneous perforating or the structuring and, if necessary, subsequent perforating with such a mould or needle-bearing plate is carried out at temperatures between 110 and 160° C. The pressing or the application of the pressing pressure is advantageously carried out with a metal roller, moving over the plate, from one side to the other, which is covered with a pressure-elastic material, corresponding to a base part 10. The contact pressure ranges between 4 and 48 kg/cm², and the pressing time with the roller ranges between 8 and 20 seconds. These conditions correspond to the conditions that are observed when structuring with a plunger.

Before structuring the pre-cut parts 30 with a plate and a metal roller loading it, the layer material had a water vapour permeability of 0.3 mg/cm²/h during an examination. After the formation of four perforations per cm², the water vapour permeability was 1.25 mg/cm²/h. The needles had a shank diameter of 1.5 mm and protruded 0.25 mm into the leather.

The roller covered with pressure-elastic material had a diameter of 28 cm. The material that was to be structured was preheated to 60° C., by means of infrared rays.

In the case of larger moulds (e.g., for half cowhides), with or without mandrels or pins 19, two rollers can be provided, between which the backing layer 1, in contact with the mould 4, is passed. In this case, one of the rollers, preferably the upper roller, has a pressure-elastic coating, which presses the layer material with the given pressure onto the metal mould 4 with its structure-giving surface of silicone rubber or textile fabric. This is the easiest method, when structuring layer material with plate-sized moulds 4 and a warm base.

Artificial leather and leather are usually structured or stamped with structured rollers. According to the invention, flat format moulds, i.e., plates, are used for structuring. This is done irrespective of whether the parts are stamped parts, small format pre-cut parts or large parts, such as half cowhides.

Corrected grain leathers, i.e., grain leathers with a minimum 0.04 mm thick stamped polymer coating, do not have any significant water vapour permeability and certainly do not, if the polymer coating is thicker than 0.075 mm, due to the fact that any previously existing water vapour permeability is lost or greatly reduced, when stamping with the usual high pressures of more than 60 kg/cm². As such, stamping large leather surfaces requires structured metal rollers or metal stamping plates. These are expensive, and usually take several weeks to procure.

In accordance with the invention, the simplest process and most economical occurs when large flat leathers are provided with layer 2 and the additional layer 3, as described, and cowhides with surfaces of e.g., 6 square metres are then halved or quartered and structured, according to the invention, by means of using moulds made of silicone rubber, textile fibres or structured paper and, if necessary, partially perforated at the same time. In the case of large format parts, it is particularly advantageous to carry out the structuring first, and then, if desired, the perforation. This is done by means of using a plate-shaped or board-shaped mould, from which metal needles or pins protrude, but the spaces between these needles or pins remains free. Such moulds cannot be used for structural stamping.

In order to create permanent partial perforations, the already structured layer material, e.g., a quartered cowhide, is placed on the needle mould, with the structured side coated with layers 2 and 3. The needle mould and the needles or pins have a temperature ranging between 90 and 150° C. The structured layer material is then pressed onto the needle mould.

In order not to damage the already structured surface of the layer material, when placing it on the needle mould, and in order to be able to easily remove the partially perforated leather or layer material from the mould, it is suggested, according to the invention, to arrange a very light, in particular elastic, compressible material, with low thermal conductivity, between the pins 19, as a so-called auxiliary material, in such a manner that not only the spaces between the needles 19 are filled, but the material also covers the needles 19. During pressing, the auxiliary material compresses in the desired manner and to such an extent that the released needles penetrate the layers 2 and 3. Suitable auxiliary materials are soft, cotton-wool-like, non-woven fabrics and foams, made of polyurethane or a soft elastomeric material, with a density ranging between 40 and 170 kg/m². This auxiliary material can be used several times.

It is therefore possible to perforate a stamped or structured layer material, after the stamping process, with a specially designed needle mould, in order to achieve the desired controllable water vapour permeability. Such perforations penetrate layers 2 and 3 and end in front of and in the surface area of the backing layer 1.

It is also possible to place the heating device 8 inside the mould 4, especially if the mould is made of silicone rubber. This design simplifies the stamping process, and the construction of the press unit required for stamping. Furthermore, the stamping temperature for the PU foam used in layers 2 and 3 can be controlled very precisely and thus, the surface structure of the layer material can be optimised.

1. A process for the production of a surface-structured layer material, which comprises a backing layer (1) and a layer (2) of polyurethane connected thereto, wherein a leather, preferably a polished grain leather or a cowhide split leather, a textile fabric, preferably a woven or knitted fabric, a cellulose fiber material, an expanded foam, a leather fiber material or a microfiber fleece is used as the backing layer (1), in particular in fragmented form, and bonded to the layer (2), wherein at least one layer, preferably a single layer of a thermoplastic PU foam, in particular one containing gas bubbles, preferably a PU expanded foam, optionally containing hollow microspheres, and/or a PU foam containing hollow microspheres, is applied to the backing layer (1) as the layer (2), characterized in that
the PU foam containing, in particular, gas bubbles, is produced with a PU dispersion mixture, the individual PU dispersions used to produce the PU dispersion mixture exhibiting different softening points in dried state,
for the production of the PU dispersion mixture, one or more PU dispersions with heat-activated melt or contact adhesive properties and with a softening point in dried state higher than 40° C., preferably higher than 45° C., in the amount of 18 to 52% by weight of the finished PU dispersion mixture and one or more PU dispersions without melt or contact adhesive properties and with a softening point higher than 95° C., preferably higher than 125° C., in the amount of 39 to 73% by weight of the final PU dispersion mixture, are mixed,
the PU dispersion mixture for the layer (2) is applied to the backing layer (1) with a thickness that, in dried state, ranges between 0.075 to 0.450 mm, preferably between 0.150 and 0.280 mm,
before or at the same time as a structuring of the PU foam, an additional layer (3) of a non-foamed PU dispersion, representing a mixture of several PU dispersions, is applied to the layer (2),
wherein the additional layer (3), which is built up with, optionally aliphatic, polyether, polyester and/or polycarbonate polyurethane, has a thickness of 0.015 to 0.060 mm, preferably 0.020 to 0.045 mm, after the solidification or drying, has a hardness greater than 70 Shore A, is not adhesive at temperatures of 125 to 165° C. and is optionally not thermoplastic.
in that the layer (2) is brought to a temperature of 110 to 165° C., preferably 120 to 155° C., with the layer (3) for structuring,
in that the cut-to-size and stamped parts (30) or the backing layer (1) are loaded during structuring, in particular to compensate for thickness variations in the backing layer (1) and to fully press the PU foam into the recesses of the mold (4) and to anchor it in the backing layer (1), by means of a pressure-elastic base part (10) which is at least as large as the part to be structured, and the backing layer (1), the additional layer (3) and the layer (2) are pressed together and bonded, by means of applying a contact pressure of 4 to 48 kg/cm2, preferably of 18 to 25 kg/cm2, and are structured with a mold (4), wherein the dried layer (2) is simultaneously or together with the additional layer (3) subjected to pressure with the structured mold (4) and a structuring is formed or stamped on the surface of the layer (2) and the additional layer (3) applied to the layer (2),
wherein the layer (2) remains thermoplastic and the layer (2) and the additional layer (3), which is thinner and harder than the layer (2), cannot be separated after three-dimensional structuring has taken place, but can still be stamped several times or can be additionally structured with other stampings.

2. Process, according to claim 1, characterized in that
the layer (2), after being applied to the backing layer (1) and before structuring, is dried to a water content of less than 1.5% by weight, preferably less than 0.5% by weight, in particular until it is free of water, and/or
an aqueous PU dispersion mixture, based on aliphatic polyether and/or polyester and/or polycarbonate polyurethane, is used to produce the PU foam, and/or
the PU dispersions are selected in such a manner that the PU dispersion mixture has thermoplastic properties after drying and also after any under-cross linking that may take place, and/or
the PU dispersion mixture used to form the PU foam contains 65 to 91% by weight—based on the total weight of the PU dispersion mixture—of PU dispersions, each of which contains 35 to 52% by weight, based on the weight of the relevant PU dispersion, of solids, and/or
the polyurethane of the PU dispersions used, which have heat-activated adhesive properties, has an at least partially linear and/or at least partially crystalline structure and/or is thermoplastic, and/or
the composition of the PU dispersion mixture is selected in such a manner that the layer (2), after drying and structuring, has a hardness ranging between 28 and 75 Shore A, preferably between 28 and 68 Shore A, in particular between 30 and 60 Shore A, and/or
the PU foam for the layer (2) is produced or composed in such a manner that the layer (2) has a density of 0.80 to 1.05 g/cm3 in its dried or almost water-free state, and/or
between 1 and 5% by weight of hollow microspheres and/or thermoplastic particles are added to the PU dispersion mixture for the layer (2), which form hollow microspheres, with a diameter of up to 40 μm, preferably between 20 and 40 μm, during the structuring, or at the temperature for structuring, in the layer (2).

3. The process, according to claim 1, characterized in that the PU foam is produced by means of introducing a gas or gas bubbles, preferably air or nitrogen, into the PU dispersion or the PU dispersion mixture, wherein so much gas is introduced or driven into one liter of the PU dispersion or PU dispersion mixture that one liter takes up a volume of 1.10 to 1.70 l, preferably 1.20 to 1.50 l.

4. The process, according to claim 1, characterized in that
molds (4) made of textile material, preferably woven, knitted or net-like materials, or molds with mold surfaces made of metallic fibers and/or threads or molds made of paper coated with plastic with a structured surface or molds produced by 3D printing processes or from low-melting metal alloys or surface-structured molds, made of silicone rubber compounds or silicone resin, which have a Shore A hardness of 25 to 98, whose density is optionally over 1.15 g/cm3 and which are optionally condensation- or addition-cross-linked, are used as molds, and/or
silicone rubber or textile material (4), which is applied to or fixed on a metal plate (20), wherein, if necessary, needle-like or mandrel-like extensions or webs, with a diameter or width of 0.8 to 1.5 mm, preferably with a tapering cross-sectional surface, which penetrate the silicone rubber material or the textile fabric, or project into the structural cavities thereof, extend from the metal plate (20), are used as materials for a mold, and/or
a PU foam is produced or used from the PU dispersions which, after drying, can be thermoplastically surface-structured.

5. The process, according to claim 1, characterized in that,
the PU foam is sprayed onto the backing layer (1), in particular airless, or is applied in the screen-printing process, or with at least one roller or a scraper, in the same thickness, —wherein the backing layer (1) is cut or stamped into pre-cut parts or cut-to-size parts (30) before or after application of the PU foam, in particular after drying thereof, and the coated pre-cut parts or cut-to-size parts (30) are subjected to stamping or structuring under pressure and temperature, and/or
a microfiber fleece is used as the backing layer (1), the spaces between the fibers of the fleece are at least partially filled with coagulated or foamed plastic foam, preferably polyurethane-based.

6. The process, according to claim 1, characterized in that, before the surface of the layer (2) of PU foam is structured on the structuring mold (4), the additional layer (3), optionally having a different color from the layer (2), is formed from a non-foamed PU dispersion, preferably a PU dispersion based on polyether polycarbonate or polyester, or a PU dispersion mixture of this type, in a thickness of 0.015 to 0.060 mm, preferably 0.020 to 0.045 mm. which contains at most 1.5% by weight, preferably a maximum of 0.5% by weight of water, in particular, is dried in an anhydrous state, has no adhesive properties, at least up to a temperature of 110° C., and is solidified and/or cross-linked to such an extent that it can be removed from the structured mold (4) without sticking to it, and in that this layer (3), which is located on the mold (4) heated to a temperature of 90 to 145° C., is brought into contact with the layer (2), is pressurized and bonded to the layer (2), during the simultaneously occurring structuring, this layer (3) advantageously having a Shore A hardness of 45 to 95, after the structuring.

7. The process, according to claim 1, characterized in that the additional layer (3) is applied to the layer (2), whereby, prior to the structuring of the layer (2) with a mold (4), the additional layer (3) of a PU dispersion or PU dispersion mixture, optionally having a different, preferably greater hardness and/or different colour color, is applied directly to the layer (2), and bonded thereto, in the course of the structuring, the additional layer (3) being formed by an non-foamed PU dispersion or PU dispersion mixture, and being applied in such a thickness that, after drying, results in a thickness ranging between 0.015 and 0.060 mm, preferably 0.020 to 0.045 mm, optionally being dried to a water content of less than 1.5% by weight, preferably a maximum of 0.5% by weight of water, in particular achieving a water-free state.

8. The process, according to claim 1, characterized in that
the mold (4) is heated to a temperature of 110 to 165° C. for structuring, a pressing or contact duration of 2 to 18 s being observed for a heated mold (4), and/or the layer (2), with the layer (3), is brought to a temperature of 110 to 165° C., in particular 120 to 155° C., e.g., with IR radiation, and is pressurized and structured with a mold (4) that is optionally heated to 110 to 145° C., and/or
in the course of structuring, perforations are formed in the layer (2) and the additional layer (3), which extend up to or into the backing layer (1), but do not penetrate the latter.

9. The process, according to claim 1, characterized in that
additives, preferably gas-filled hollow microspheres and/or pigments and/or polyacrylate dispersions and/or silicones and/or delustering agents and/or thickeners and/or cross-linking agents and/or foaming aids and/or flame retardants, are added to the PU dispersion or PU dispersion mixture, and/or
the PU foam is subjected to heat and pressurized in such a manner that the layer (2), after the structuring with the mold (4), has a density of 0.80 to 1.050 g/cm3, preferably 0.810 to 0.970 g/cm3, and/or
cross-linking agents are added to the PU dispersion mixture in an amount of up to 4.2% by weight, preferably from 0.9 to 3.2% by weight, based on the total weight of the PU foam, and it continues to be thermoplastic, even after structuring under pressure and temperature, and/or
8 to 25% by weight, based on the total weight of PU foam, of a 40 to 60% acrylate dispersion, is added to the PU dispersion mixture, and/or
PU dispersion mixtures are used for the production of the PU foam, in which, after a drying process, a dried layer of the PU foam produced therewith, with an area of 1 m2 and a thickness of 1.0 mm, weighs 0.800 to 1.050 kg before being structured, and/or
format parts or stamped parts are separated and stamped from a large-area backing layer (1) coated with PU foam, and/or
the layer (2) and the additional layer (3) are formed with a different composition and/or pigmentation or color, in particular with a different content of cross-linking agent, and exhibit thermoplastic behaviour behavior, and/or
a color layer or finishing layer (6) is applied to the additional layer (3), before the structuring, this color or finishing layer advantageously having been printed on and, if it is the case, formed by a plastic film adhering to the layer (3) or capable of being bonded thereto, or a color layer or colored patterns or encompassing color patterns, and/or
stamped parts or format parts (30) machined out of the layer material, structured under the predetermined pressure and temperature, and/or
for the stamping or structuring operation, a layer or plate or a base part (10) of pressure-elastic material is disposed between a plunger (12) and the stamped part (30) or the backing layer (1) of the layer material (1), the pressure-elastic material being an elastomeric foam, a pressure pad filled with gas or liquid, having flexible walls or a felt or non-woven material impregnated with elastomers, e.g., silicone rubber, and/or
in that the pressure-elastic base part (10), advantageously in the form of a pressure plate, is fastened to a plunger (12), and/or
in that the pressure-elastic material of the base part (10) can be compressed by more than 4% at a pressure of 10 kg/cm², and/or
in that the base part (10) has a thickness of 1.5 to 12 mm, preferably 1 to 8 mm, and/or
in that the base part (10) resets in less than 4 s after a pressure relief, and/or
in that the Shore A hardness of the base part (10) is comparable with the Shore A hardness of the mold (4), and/or
the structure-forming surface area of the mold (4) is formed to be air-permeable or gas-permeable, in directions parallel to its surface, and is advantageously formed with textile material or threads or fibers.

10. The process, according to claim 1,
characterized in that before the layer (2) of PU foam is applied to a backing layer (1) made out of textile fabric, e.g. woven or knitted fabric, a thin layer (5) of optionally foamed soft PVC or foamed or non-foamed cross-linkable PU dispersion or non-foamed, cross-linkable PU dispersion mixture of aliphatic and/or aromatic polyurethane, based on polyester or polyether of a cross-linkable polyacrylate dispersion, which represents a connecting layer for the layer (2) of PU foam to be applied to the layer (1), has a thickness of 0.25 to 0.40 mm, after drying.

11. A layer material, comprising a backing layer (1) and a layer (2) of polyurethane bonded thereto, wherein the backing layer (1), which is present, in particular, in fragmented form, is leather, preferably grain leather, in particular polished grain leather or cow split leather, a textile fabric, preferably a woven or knitted fabric, a cellulose fiber material, an expanded foam, a leather fiber material or a microfiber fleece, produced by a process according to claim 1, characterized in that
the layer (2) is formed by at least one layer, preferably a single layer, of a non-cross-linked or under-cross-linked PU foam, in particular a PU foam containing gas bubbles, preferably a PU expanded foam, optionally containing hollow microspheres, or a PU foam containing hollow microspheres, which optionally has a maximum water content of 1.5% by weight, preferably 0.5% by weight, in particular water-free, the layer (2) having a softening point above 90° C. and being adhesive at a temperature of 110 to 165° C., having thermoplastic properties and being flowable and deformable under pressure, and
an additional layer (3) of a non-foamed PU dispersion is applied to the layer (2) and is bonded to this layer (2) and on the surface of the layer (2) and the additional layer (3) applied to the layer (2) a structuring is formed or stamped, respectively.

12. Layer material, according to claim 11, characterized in that,
the PU foam of the layer (2) has a specific weight of 0.800 to 1.050 g/cm3, and/or
the layer (2) of PU foam has a thickness of 0.075 to 0.450 mm, preferably 0.150 to 0.280 mm, and/or
the polyurethanes used for the layer (2) are aliphatic polyurethanes, based on polyether or polyester or polycarbonate, and/or
the layer (2) of PU foam contains pigments and/or cross-linking agents and/or polyacrylates and/or hollow microspheres and/or delustering agents, and/or
the layer (2) of solidified, dried PU foam has a Shore A hardness of 28 to 68, and/or
the layer (2) contains 0 to 4.2% by weight, based on the total weight of the layer (2), of cross-linking agents, and/or
the layer (3) is not adhesive or not yet adhesive at temperatures of 125 to 165° C., and/or
perforations are formed in the layer (2) and in the additional layer (3) of the layer material.

13. Layer material, according to claim 11 or 12, characterized in that, in the case of an backing layer (1) formed by a textile fabric, a thin layer (5) of foamed soft PVC or cross-linked foam layer of a PU dispersion or polyacrylate dispersion is formed between the textile fabric and the layer (2), and the layer (5) has a thickness of 0.25 to 0.45 mm, and represents a connecting layer for the layer (2) of PU foam that is to be applied, the two layers (2, 5) optionally forming a total thickness of 0.30 to 0.60 mm.

14. Layer material, according to claim 11, characterized in that the thin, heat-structural, non-foamed layer (3) applied or bonded to the layer (2) and made of a PU dispersion or PU dispersion mixture, based on an aliphatic polyether polycarbonate and/or polyester, has a thickness of 0.0150 to 0.060 mm, preferably 0.020 to 0.0350 mm, wherein a structure corresponding to the structural stamping in the layer (3) is formed or stamped in the layer (2) of PU foam, and wherein the layer (3) advantageously has a greater Shore A hardness than the layer (2), or a hardness of more than 70 Shore A, preferably between 78 and 98 Shore A, and optionally contains 1 to 4% by weight of polysiloxanes.

15. Layer material, according to claim 11, characterized in that,
the grain leather is a full-grain cowhide, preferably cow split leather, calf leather, goat leather, lamb leather, water buffalo leather, pig leather, sheep leather or kangaroo leather, in which the grain layer is advantageously mechanically removed by at least 5%, and/or
the fibers of the microfiber fleece consist of polyester or polyamide, the cavities between the fibers are impregnated or filled, respectively, with a plastic, preferably polyurethane-based or polyester-based, which has a foam structure or a coagulated microcell structure, and/or
the leather fiber material contains between 13 and 48% by weight of synthetic fibres fibers, and/or
the PU foam has a microcellular structure and/or is permeable to air and/or has a water vapor permeability of over 0.50 mg/cm2/h, preferably over 0.12 mg/cm2/h, according to DIN EN ISO 14268, and/or
the layer material is in the form of a stamped part or pre-cut part (30), and/or the backing layer (1) is air-permeable, in particular in directions parallel to its surface, and is advantageously formed with textile material or fibers or threads.

16. Articles produced using a layer material, according to claim 11, such as meter goods, pre-cut parts, stamped parts, shoe parts, sports and work shoes, shoe insoles, bags, leather goods, steering wheel covers, upholstery covers, interior wall linings of vehicles and seat covers for motor vehicles, wherein the surface of the articles and the layer (2) and the layer (3) have a structural stamping.

17. Article, according to claim 16, characterized in that
the layer (2) and, as the case may be, also the additional layer (3) bonded to the layer (2) or applied to the layer (2) is thermoplastically deformed or structured and deformable and structurable, by applying heat and pressure, and/or
a color or finishing layer (6), which is preferably of a different color and is formed from a colored PU mixture and, if appropriate, has the same thickness and/or hardness and consistency as the additional layer (3), is applied to stamped or format pre-cuts (30) on the additional layer (3).
